(19) United States
(12) Patent Application Publication
(10) Pub. No.: US 2009/0238426 A1
(43) Pub. Date: Sep. 24, 2009

(54) System and Methods for Identifying an Object within a Complex Environment

(75) Inventors: Elise Fear, Calgary (CA); Douglas Kurrant, Calgary (CA); David Westwick, Calgary (CA)

Correspondence Address: FULBRIGHT & JAWORSKI L.L.P., 600 CONGRESS AVE., SUITE 2400, AUSTIN, TX, 78701, US

(73) Assignee: UTI LIMITED PARTNERSHIP, Calgary (CA)

(21) Appl. No.: 12/407,671

(22) Filed: Mar. 19, 2009

Related U.S. Application Data
(63) Continuation of application No. 61/038,022, filed on Mar. 19, 2008.

(51) Int. Cl. G06K 9/00; G06K 9/46

(52) U.S. Cl. 382/128; 382/190; 382/154

(57) ABSTRACT

A signal processing technique includes extracting object features, an object response classification, and a reconstruction of the object estimate. In selected embodiments, an optional step that improves the estimate of the object response is included in the signal processing technique. In one implementation of the signal processing technique, reflections from the surrounding environment are removed from the response of a target object to permit the identification, localization, and imaging of the target. In select implementations, the technique can be used to image tumors located within breast tissue.

### CROSS-REFERENCE TO RELATED APPLICATIONS

This application claims priority to U.S. Provisional Application No. 61/038,022 filed Mar. 19, 2008, the entire disclosure of which is specifically incorporated herein by reference without disclaimer.

### TECHNICAL FIELD

This disclosure relates to object identification, and more particularly to object identification within a complex environment.

### BACKGROUND

Objects partially or fully obscured within an environment can be detected by a variety of methods, often while leaving the surrounding environment in tact. This can be an advantageous approach over more invasive methods when damage may be done to the environment surrounding the object of interest, or when it may be hazardous to remove portions of the environment.

Various imaging techniques are used in medicine to determine structural features within the body without subjecting the patient to an invasive surgical procedure. As an example, magnetic resonance imaging (MRI) and X-ray imaging can be used to study tissue and bone structures respectively. Diagnostic sonography or “ultrasound” can image muscles, tendons, and internal organs, and is a common modality for fetal monitoring in prenatal care. Radar based microwave imaging techniques are being investigated for diagnosing breast cancer that is at an early stage.

Some imaging techniques rely on computer software or hardware to transform image object data into a recognizable form. For example, in radar based microwave imaging systems, software is often used to transform raw electromagnetic field data received from an array of antennas into an image that resembles a biological structure of interest.

### SUMMARY OF THE INVENTION

From the foregoing discussion, it should be apparent that a need exists for a system and methods for identifying an object within a complex environment. More particularly, a need exists for a method for finding a tumor within breast tissue.

A system for identifying an object within a complex environment is presented. In one embodiment, the system includes an energy source, a receiver, and a computing system. In such an embodiment, the energy source may irradiate an environment with electromagnetic energy. The receiver may receive reflections of the electromagnetic energy from an object within the environment and generate a response signal associated with the received reflections. In one embodiment, the computing system may be configured to execute predetermined instructions. For example, the instructions may include receiving the response signal corresponding to the reflections of the energy source, extracting a feature of the object within the environment from the response signal reflected by the object, estimating a location of the object within the environment from the object response, comparing the feature of the object with a feature associated with an object of interest, classifying the object in response to a physical location of the object and the comparison of the feature of the object with the feature of the object of interest, reconstructing an object estimation in response to the classification, and generating an image of the object in response to a determination that the object is classified as an object of interest.

A tangible computer program product comprising computer readable instructions that, when executed by a computer, cause the computer to perform certain operations is also presented. In one embodiment, the operations may include extracting a feature of an object response from a signal reflected by an object embedded within an environment, estimating a location of the object within the environment from the object response, comparing the feature of the object response with a feature associated with an object response of interest, classifying the object in response to a physical location of the object and the comparison of the feature of the object with the feature of the object of interest, reconstructing an object estimation in response to the classification; and generating an image of the object in response to a determination that the object is classified as an object of interest.

A method is also presented for identifying an object within a complex environment. The method in the disclosed embodiments substantially includes the steps necessary to carry out the functions presented above with respect to the operation of the described system and computer readable medium. In one embodiment, the method includes extracting a feature of an object response from a signal reflected by an object embedded within an environment, estimating a location of the object within the environment from the object response, comparing the feature of the object response with a feature associated with an object response of interest, classifying the object in response to a physical location of the object and the comparison of the feature of the object with the feature of the object of interest, reconstructing an object, estimation in response to the classification; and generating an image of the object in response to a determination that the object is classified as an object of interest.

In a further embodiment, the extracting the features of the object response may include receiving a time-domain energy reflection signal from within the environment, dividing the time-domain energy reflection signal into one or more windows comprising time-domain data, and comparing the time-domain data in the one or more windows with known object responses from a database of object responses. Receiving the time-domain energy reflection signal from within the environment may include directing an energy source into the environment and receiving a reflection from the object within the environment with one or more receiving antennas.

In one embodiment, extracting the feature of the object response may include modeling the object response with a piecewise parametric function of time and estimating parameters using a statistical signal processing estimation technique.

In a further embodiment, classifying the object may include comparing the time domain data with object responses recorded at one or more additional sensors to identify similar responses. In an alternative embodiment, classifying may include comparing an object response received by one or more receivers with a reference response, the receivers defining an n×m array, identifying an object response most similar to the reference response, selecting a set of one or more initialization points associated with the object, response that is most similar to the reference response, estimating a location of a source of the object response, predicting a time-of-arrival of the object response received by an unclassified receiver according to the location of the source of the object response, comparing the predicted time-of-arrival of the object response with an actual time-of-arrival of the response acquired by the unclassified receiver, and determining that the object response received by the unclassified receiver is associated with the source of the object response according to a determination that the time-of-arrival of the response received is substantially the same as the predicted time-of-arrival of the response, and the response received by the receiver is similar to a reference response.

In one embodiment, transforming the one or more feature vectors may include substituting elements of the object response into a response model comprising a time-independent scaling factor, an object reference response, a time delay between an actual object response and a reference signal, and a damping factor.

In a further embodiment, the method may include identifying non-target signals corresponding to clutter, and removing the non-target signals from the total signal.

Additionally, identifying non-target signals corresponding to clutter may include transforming an object estimate and signal data into the frequency domain, providing a parameter space from which to extract relevant features from the signals, and removing a clutter estimate from the total signal. In a further embodiment, transforming an object estimate and signal data into the frequency domain may include identifying poles corresponding to clutter. Identifying poles corresponding to clutter may include using the TLS-Prony method.

In a further embodiment, object is a tumor and the environment is breast tissue in proximity to the tumor.

Alternatively, the method may include irradiating body tissue with electromagnetic, energy, capturing reflections of the electromagnetic energy at a plurality of receivers, generating a plurality of signals, each signal associated with the reflections captured by one of the plurality of receivers, performing a tumor response estimation that extracts information related to a tumor response from the plurality of signals, performing a tumor classification to identify and localize a source of a tumor response and determine that the tumor response is associated with a tumor, reconstructing the tumor response according to an object estimation reconstruction, removing signals that do not correspond to reflections from the tumor, and creating an image of the tumor, the image being substantially devoid of image artifacts.

In one embodiment, the energy is broad-band or ultra-wideband microwave energy. In a further embodiment, irradiating the body tissue with electromagnetic energy and the capturing reflections of the electromagnetic energy at a receiver is accomplished by an antenna that can both emit and receive microwave energy. Additionally, imaging the object within the body tissue may include processing signals from a tissue sensing adaptive radar apparatus.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### DESCRIPTION OF DRAWINGS

FIG. 1 is a flow diagram of a method, according to one embodiment.

FIG. 2 is a flow diagram of a process, according to one embodiment.

FIG. 3 is a chart of voltage over time for a signal.

FIG. 4 is an illustration of a classification process, according to one embodiment.

FIG. 5 is an illustration of a classification process, according to one embodiment.

FIG. 6 is a measurement geometry, according to one embodiment.

FIG. 7 is a flow diagram of a process, according to one embodiment.

FIG. 8 is block diagram of the object response estimate enhancement process.

FIG. 9 is a chart showing voltage over time of an object signal.

FIG. 10 is a chart showing voltage over time of an object signal.

FIG. 11 is a chart showing voltage over time of an object signal.

FIG. 12 is a chart showing voltage over time of an object signal.

FIG. 13 is a reconstructed image of a breast model.

FIG. 14 is a reconstructed image of a breast model.

FIG. 15 is a reconstructed image of a breast model.

FIG. 16 is the cylindrical breast model used to generate simulated data.

FIG. 17 is the realistic breast model used to generate simulated data,

FIG. 18 is a representation of two antenna arrays, according to one embodiment.

### DETAILED DESCRIPTION OF ILLUSTRATIVE EMBODIMENTS

In general, objects can be imaged or resolved from a surrounding environment by exposing the environment to an energy source, such as a directed electromagnetic or ultrasonic wave, and capturing reflections of the energy at a receiver from objects within the environment. The energy source and the receiver can be coupled to electronic equipment that can determine features of the object, if present, such as the depth of the object from a surface, the size, density, shape, location, and other characteristics of the object. In some cases, processes are used to transform raw data, such as the intensity of backscattered energy from an object, into an image of the object that resembles the true characteristics of the object. In some embodiments, energy is microwave energy. In some embodiments, the electromagnetic wave is broad-band or ultra-wideband microwave energy, for example, microwave energy in the range of 2 to 13.5 GHz.

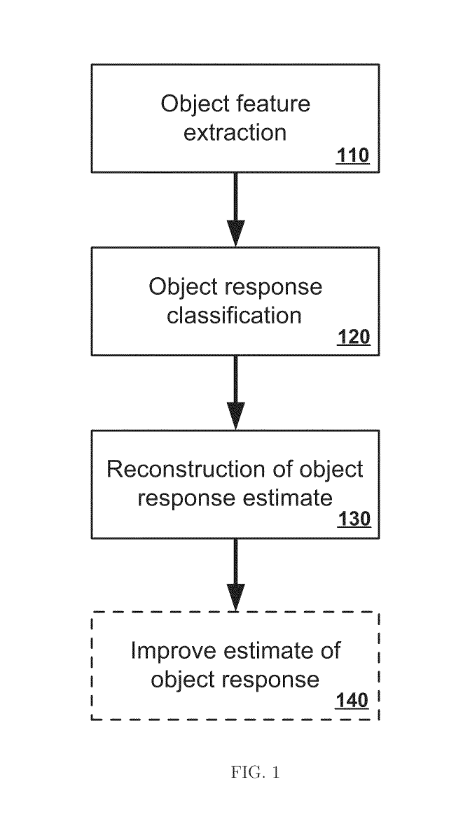

FIG. 1 is a flow diagram 100 of one embodiment of a method for imaging an object. In this particular embodiment, the method includes four steps, although additional steps may be included. The flow diagram 100 outlines steps for processing data received by imaging hardware, such as an antenna or receiver that can capture energy that has reflected off of an object within an environment. In certain embodiments, the image data may be captured by a receiver that receives signals corresponding to electromagnetic waves reflecting from an object within an environment. The object may be one that is obscured from view, such as by being buried underground, or contained within an opaque or non-transparent medium, or the object may be cloaked in darkness or contained within a medium that makes its viewing difficult.

The method can be executed on a computing system. Non-limiting examples of computing systems include personal computers, computer networks, supercomputers, and workstations. In an alternative embodiment, the method may be executed by an embedded microcontroller or FPGA, or other dedicated hardware components. The computing system may be directly interfaced with other hardware and software systems, i.e., other computer systems, and instruments that allow the collection of imaging data. In some embodiments the computing system may be coupled to imaging hardware that may include, for example, an energy source that transmits energy into an environment, and a receiver or antenna system that can receive backscattered energy from objects within the environment. In some embodiments, the energy source and the antenna system are the same, meaning that one device both transmits energy into the environment and receives backscattered signals from objects within the environment. In other embodiments, the energy source and the antenna system are decoupled. In some embodiments, multiple energy sources and multiple antenna systems can be used to interrogate one environment. In some embodiments, an energy source/antenna system can be moved around an environment of interest so as to produce a synthetic array of antennas that captures a region of the environment.

In some embodiments, the method is stored on a computer readable medium comprising computer readable instructions that, when executed by the computing device, cause the computer to perform the various method steps. Non-limiting examples of computer readable media include hard disk drives, computer memory, e.g. random-access-memory (RAM) or read-only-memory (ROM), and universal-serial-bus (USB) drives. The computer readable medium allows storage of instructions, including instructions to carry out the method, so that a computer processor may execute the method and return a tangible result. In some embodiments, a tangible result includes the formation of an image file from raw image data after it has been processed through the method. In similar embodiments, a tangible result includes displaying a computer-rendered image of an object based on the output of the method on a viewscreen, such as a computer monitor.

In certain embodiments, a computer system that performs operations of the method is decoupled from the instruments or other hardware that collects the raw image data. In other words, one system can perform the operations related to collecting raw image data, and another system can perform the operations relating to calculating an output.

The method presented in FIG. 1 is illustratively broken into four steps. Those skilled in the art will recognize that the steps presented in FIG. 1 can be combined into one contiguous method that may be executed on, for example, a computing system. An overview of the four steps is presented below, followed by the details of each step of the method.

Steps 110 and 120 combine to permit the detection of a response in a signal. Since an object is characterized by its response, detection of the response leads to the identification and localization of an object of interest. In Step 110, feature information related to the response associated with the object of interest, is extracted. This includes how closely the information present in the signal matches the information present in the object response. The feature information that the method is capable of extracting from the signal depends on the object response used. To increase the flexibility of the method, a database of object responses may be used. This capability generalizes the applications of the method. For example, in one embodiment, a set of object responses associated with different land mines may be used to acquire land mine information from the signal. In another embodiment where tumor detection is of interest, a set of object responses related to tumors having different geometrical and electrical properties may be used to acquire a variety of tumor response information from a signal.

Step 120 is a classification method that is applied to the feature information extracted from Step 110. The method first identifies and localizes the physical source of the signal. Next, the feature information is examined to determine if it originated from an object of interest. The decision is based on how closely the feature information matches the object response information. Knowing both the physical location of the source of the signal, and how closely the signal information matches the object response information allows the classification method to identify and localize an object of interest. This approach permits the method to be applied to a variety of situations where the physical location of an object is unknown, but needs to be determined. A list of possible embodiments include, but are in no way limited to, locating tumors embedded in breast tissue, locating buried land-mines, finding underground electrical and natural gas utilities, identifying the location of mineral deposits, detecting explosives in luggage, and identifying buried human remains.

Step 130 is applied to the output of Step 120 so that signals identified to be associated with an object of interest may be reconstructed to form a three dimensional image.

An optional Step 140 is included in the flow diagram 100, so indicated by the dashed line. This optional Step 140 permits an improvement of the estimate of the object response. As a broad overview of this Step 140, components of a signal which may have been identified as clutter, i.e., signals that are not indicative of an object of interest are further processed. Processing of the clutter may include identification and classification of the clutter. This additional knowledge may, in turn, be used to extract more detailed information about the object of interest.

Details of the method steps described in FIG. 1 are now described according to certain implementations of the above embodiment. Other methods may be used to accomplish the goals of each step.

Extracting Object Features—Step 110

An object signal may be pre-conditioned to remove known sources of noise and signals corresponding to objects of non-interest. The pre-conditioned signal may be modeled as,

x(n)=t(n)+c(n)+w(n), n=0, . . . , N−1 (1)

where x(n) represents the pre-conditioned signal, t(n) represents the contributions from the object, c(n) represents clutter contributions, w(n) represents additive white Gaussian noise, and N is the duration of the received signal. A time domain parametric function can be used to estimate the object contributions in (1) as,

$$t ( n ) = \{ \begin{matrix}A {t}_{α} ( n - {t}_{d} ) , & n = 0 , … , {t}_{d} \\ A {e}^{n γ} {t}_{α} ( n - {t}_{d} ) , & n = {t}_{d} , … , N - 1\end{matrix} \qquad ( 2 )$$

where A is a time independent scaling factor, t_{α}(n) is an object reference response, t_{d} is the time delay between the actual object response and the reference signal, and γ is a damping factor. A set of reference signatures can be generated using finite difference time domain (FDTD) simulations of nᵣ selected object models. Acquisition of the set of nᵣ reference responses is described below. The nᵣ responses can be assembled into an indexed set given by t_{α}(n)ε{t_{α}: αε∀, ∀={1, 2, . . . , nᵣ}}. The set of reference signatures characterizes the response of an object over a fixed range of geometrical and electrical properties with the removal of all unwanted contributions arising from the scattering mechanisms within the surrounding environment. In some cases, differences exist between the early and late time object response. The piecewise function given by Equation (2) can therefore be introduced to accurately model the temporal object response.

In some implementations of the method, a library of object responses can be used to create reference sets. For example, known ranges of electrical properties of certain objects may be incorporated into the refined object response reference signature set. Furthermore, in a practical system, an object response set may be obtained using information from other imaging modalities. For example, the shapes and sizes of objects such as tumors, e.g., tumors within breast tissue, may be estimated from x-ray mammograms or magnetic resonance images. These data may be used in simulations to obtain the tumor response reference signals.

A computer process can accurately estimate the value of each parameter in Equation (2). These parameters are represented in vector form as θ=[A γ t_{d} α]^{T}. The range of values that each parameter can assume can be physically constrained by the system, i.e., the electrical and geometrical properties of the model being used and the characteristics of the signal receiving system. This observation implies that the true value of a parameter is chosen from an assumed fixed interval.

The maximum value that A can assume is the ratio of the maximum value of the signal to the maximum value of the reference signature. The damping of the reference signal can depend on the permittivity contrast between the object used to acquire the reference signal and the surrounding environment. Likewise, the damping of the object response for each test may depend on the permittivity contrast between the object and the surrounding environment. If the contrast is the same for both the reference object and the object under consideration, then the damping factor will be the same. As the permittivity contrast decreases, then the damping factor increases.

The time delay parameter (t_{d}) is the time delay between the maximum of the actual object response and the reference signal. The maximum value of the object reference usually occurs at the transition between the early and late time response. Hence, M, the maximum value of the time delay, is the duration of the entire signal. N−1, minus the duration of the late time response of the reference signal. The index, α, indicates which of the nᵣ reference responses is selected. In some implementations of the method, the range of values for each parameter is based on a model that incorporates a variety of realistic target geometries and properties. In some models, the feasible ranges of values for the damping factor (γ) and time delay (t_{d}) may be modified as required.

A Bayesian estimation technique can provide one mechanism to incorporate the prior knowledge about each parameter into the estimator. Each parameter, θₘ, m=1, 2, 3, 4, can be modeled as a stochastic variable with its own probability density function (pdf), p(θₘ), having finite support and a non-zero real valued variance σ_{θm}². Initially the estimation of the continuous parameters (A and γ) can be considered by assuming that each discrete parameter (t_{d} and α) is constant. In particular, each continuous parameter can be modeled as a random variable with a uniform pdf given by,

$$p ( {θ}_{m} ) = \frac{1}{{b}_{m} - {a}_{m}} , {θ}_{m} ∈ [ {a}_{m} , {b}_{m} ] , m = 1 , 2 \qquad ( 3 )$$

where aₘ and bₘ are the boundary points of the range of values identified for each parameter. By assumption, the noise, w(n), is derived from a zero mean, white Gaussian process with a variance of σ². Hence, the prior conditional probability p(x|θ) also follows a Gaussian distribution with mean t(n)+c(n) and variance σ² and is given by,

$$p ( x \vert θ ) = \frac{1}{{( 2 π {σ}^{2} )}^{\frac{N}{2}}} {e}^{\frac{- 1}{2 {σ}^{2}} {\sum }_{n = 0}^{N - 1} {( x ( n ) - t ( n ) - c ( n ) )}^{2}} . \qquad ( 4 )$$

An optimal approach to estimate θ is finding the maximum of the posterior pdf. For example, a maximum a posteriori, probability (MAP) approach, which chooses the value of θ to maximize the posterior pdf or,

$${\hat{θ}}_{map} = arg [ {max}_{θ} p ( θ \vert x ) ] . \qquad ( 5 )$$

Applying Bayes Rule to the posterior pdf followed by the application of the gradient operator may be used to yield the result.

∇_{θ}[ln p(x|θ)]_{θ=\hat{θ}}_{_{MAP}}=0. (6)

Computing the logarithm of (4) leads to,

$$ln p ( x \vert θ ) = \frac{- N}{2} ln ( 2 π {σ}^{2} ) + \frac{- 1}{2 {σ}^{2}} {\sum }_{n = 0}^{N - 1} {( x ( n ) - t ( n ) - c ( n ) )}^{2} \qquad ( 7 )$$

After simplification, (7) becomes,

$$ln p ( x \vert θ ) = K + \frac{1}{{σ}^{2}} ( {\sum }_{n = 0}^{N - 1} t ( n ) ( x ( n ) - c ( n ) ) - \frac{1}{2} {E}_{t} ) \qquad ( 8 )$$

where K is a constant independent of θ, and Eₜ is the energy of the object response. Equations (6) and (8) imply that maximizing the posterior pdf is equivalent to maximizing the cross-correlation function. The cross-correlation function may be normalized resulting in the following cost function.

$$J ( θ ) = \frac{1}{N} {\sum }_{n = 0}^{N - 1} \frac{t ( n ) ( x ( n ) - c ( n ) )}{\sqrt{{E}_{t} {E}_{xc}}} , \qquad ( 9 )$$

where Eₜ and E_{xc} are the energies of the object and difference signals, respectively.

To complete the analysis, the assumption that the discrete parameters are constant can be relaxed. By assumption, the value of each discrete variable is derived from a fixed set of elements (t_{d}εT_{d}={0, 1, . . . , M−1}, M<N, αε∀), and may assume the value of any element in the respective set with equal probability. Hence, each discrete random variable follows a discrete uniform pdf. Each discrete variable can be incorporated into the search space over which the cost function is maximized. This yields a MAP which takes the following final form,

$${\hat{θ}}_{map} = arg [ {max}_{θ} \{ J ( θ ) , ∀ α ∈ Λ , ∀ {t}_{d} ∈ {T}_{d} \} ] . \qquad ( 10 )$$

The computation of (10) requires the maximization of a cost function over a multidimensional search space in [symbol] Furthermore, it is observed that the cost function is non-convex, leading to multiple local maxima. Since the goal is to find the maximum value over the entire search space, a numerical grid search technique is used. The range of each parameter or variable defines the search space in [symbol] Starting with the first element of the base reference set (i.e. t_{α=1}(n)), the technique iteratively selects a reference signature. For each reference signature selected, the technique then extracts the parameters from the search space that maximize the cost function. The index of the reference signature along with the associated set of parameters extracted is used to compute the value of the MAP. A mesh size is used that balances the requirement of achieving satisfactory estimates of the parameters (in terms of precision) without using an excessive amount of computational resources.

Windowed Estimates

The computation of x(n)−c(n) in (9) can require full knowledge of the clutter, which is not possible in most circumstances. This problem can be overcome with an iterative process that uses a short duration temporal window. It can be assumed that the object response is contained within the window, while the clutter is outside of the window. The MAP given by (10) is then applied to the signal contained within the window to evaluate estimates of the function parameters. The temporal window then incrementally slides across the signal, x(n), while the MAP evaluates function parameter estimates at each iteration.

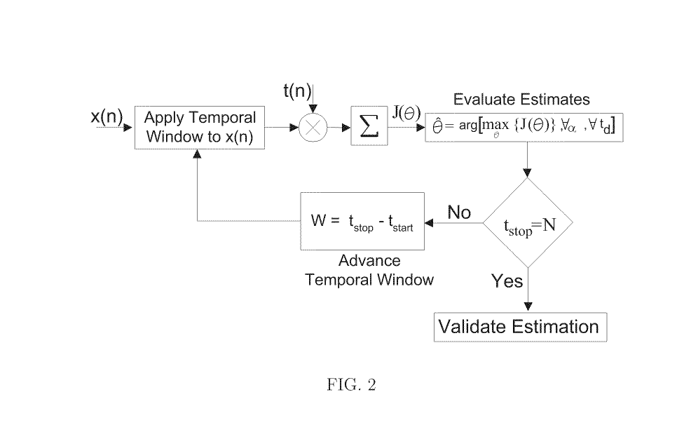

The process is shown in FIG. 2, and begins by initializing the start of the window, tₛₜₐᵣₜ, to the beginning of x(n). For the initial window, the process finds the first peak value of the entire pre-processed signal, SIGNALₘₐₓ₁. Starting with the first element of the base reference set (i.e. t_{α=1}(n)), the process iteratively selects a reference signature. It then adjusts the time delay, t_{d}, and the scaling factor, A, such that the peak value of the reference signature lines up and is scaled to match SIGNALₘₐₓ₁. The process then completes a line search for the damping factor that maximizes Equation (9). Once the parameters are estimated by the MAP, the temporal window is shifted by setting tₛₜₐᵣₜ to the time corresponding to the first zero crossing of x(n) after \hat{t}_{d}_{₁} which is the time delay corresponding to the peak value of the cost function for the first temporal window. Thus, the magnitude of the time shift dynamically adjusts to suit the signal x(n). The first peak value of the entire signal after this zero crossing is then determined. The steps used to estimate the model parameters for the first window are then repeated.

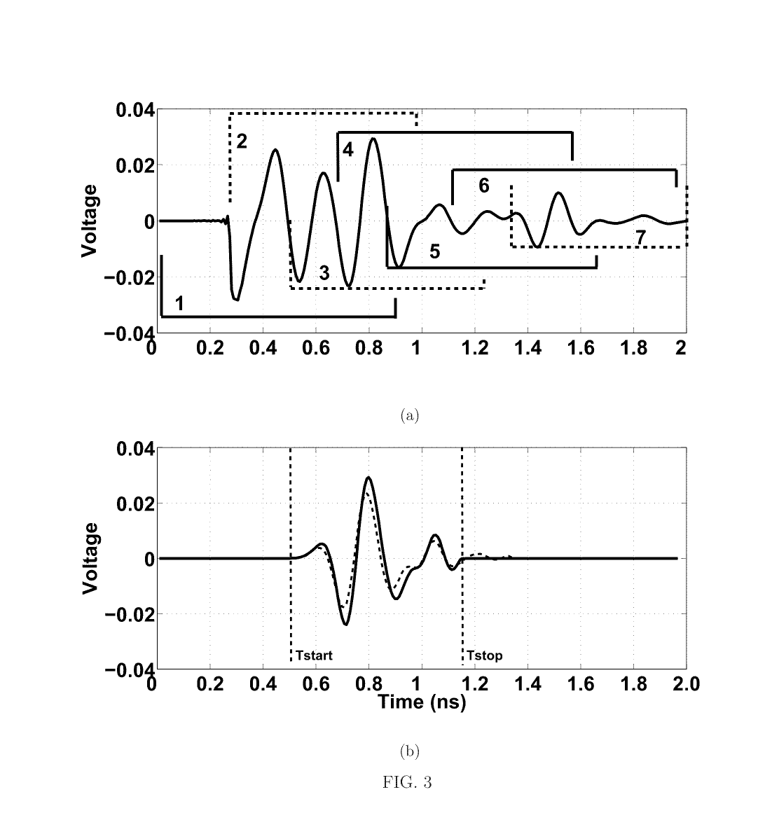

The duration of the window is defined as, W=tₛₜₒₚ−tₛₜₐᵣₜ, where tₛₜₒₚ is the end of the window which corresponds to the end of the reference signal. The end of the reference signal is selected so that the energy has attained a low level (e.g., < 10%). FIG. 3 shows the application of the technique to pre-processed TSAR data. In FIG. 3(a), the TSAR signal is segmented by multiple overlapping temporal windows, while in FIG. 3(b), the tumor estimate (broken line) is superimposed onto the actual tumor response (solid line). FIG. 3(b) illustrates the relation of tₛₜₒₚ and tₛₜₐᵣₜ with a typical reference signal. The process is repeated until the temporal window reaches the end of x(n). At the termination of the process, L prospective object estimate candidates have been computed and stored for further evaluation.

The maximum value of the cost function describes how closely the estimate matches the signal contained within the window. Therefore, the result is augmented to the vector of parameter estimates to form a five-dimensional estimation vector \hat{f}ₖ=[Âₖ \hat{γ}ₖ \hat{t}_{d}_{ₖ} \hat{α}ₖ \hat{ρ}ₘₐₓ_{ₖ}]^{T}, where \hat{ρ}ₘₐₓ_{ₖ}=J(\hat{θ}ₘₐₚ), and k is an index indicating with which of the L temporal windows the vector is associated. We describe \hat{f}ₖ as a feature vector, since it summarizes the feature information contained within the window that is related to an object response. Other features may be extracted from the signal by computing ratios (e.g. the energy ratio), or using a similarity measure that incorporates the L1, or L2 norm.

Object Response Classification—Step 120

In the object response classification method for step 120 signals may be recorded at an n×m array of receivers, e.g., antennas, with individual elements denoted as (i, j). This section describes one method for classifying the object responses. Another procedure is described in the Alternative Object Response Classification section. The Bayesian estimator can summarize the feature information contained in each signal and compress the data into a lower dimensional space. The feature information acquired for receiver (i, j) is, in turn, stored in a feature space, [symbol] defined as,

[symbol]

=span{\hat{f}_{i,j}¹,\hat{f}_{i,j}², . . . , \hat{f}_{i,j}^{L}}, (11)

where \hat{f}_{i,j}^{k} is the feature vector associated with the k^{th} temporal window, and L is the maximum number of temporal windows used to extract the response information.

A goal is to determine which one (if any) of the L feature vectors contained in the space is associated with an object response. The following two step procedure is used, in some implementations, to achieve this goal: (1) initialization points are identified, and (2) starting with the initialization points, all feature vectors are classified. The procedure uses the time delay (\hat{t}_{d}_{_{i,j}}^{k}), and the peak value of the cost function (\hat{ρ}_{i,j}^{k}) associated with the feature vector. In one embodiment, the time delay may be interpreted such that it represents a measurement of the time-of-arrival of the object's response. Furthermore, the peak cost function value may be interpreted as how close the information contained in the object's response matches the information contained in the reference response.

Finding a Set of Initialization Points

A set of initialization points can be selected by choosing the feature vector with the highest peak cost function value amongst all of the receivers interior to the n×m synthetic array (i.e. receivers along the boundary of the array are not considered). The feature vector found using this criterion is identified as \hat{f}_{u,v}ⁱⁿⁱ with an associated time delay, \hat{t}_{d}_{_{u,v}}ⁱⁿⁱ. In some implementations, a 3×3 window is formed with antenna (u, v) at the center. For the alternate classification step, this condition is relaxed. Instead, an initialization window in the form of a cross as shown in FIG. 5 is formed. FIG. 5 shows an illustration of the classification process for an antenna array. On the left, a single antenna is scanned in an elliptical pattern around the breast to construct a synthetic array shown on the right. In step 1, the process is initialized by finding a 5-element cluster of antennas that have detected a tumor response. In step 2, the spatial window is expanded to form a 3×3 array of antenna elements. The vectors in the four unclassified antennas of the spatial window are then classified. In step 3, antennas adjacent to the spatial window from step 2 are classified. The procedure continues by expanding spatial window outward adding antennas for classification.

Next, a determination is made as to whether any of the other receivers contained in the 3×3 window surrounding receivers (u, v) contain contradictory information using a two step procedure:
1. For receiver (i, j), the feature vector with the largest peak cost function value is selected and identified as f_{i,j}^{test}. That is,

\hat{f}_{i,j}^{test}=f_{i,j}^{max} when \hat{ρ}_{i,j}^{max}=max{\hat{ρ}_{i,j}^{k}} for k=1, . . . , L, (12)
where k is an index used to identify which feature vector in the feature space is being evaluated, and \hat{f}_{i,j}^{max} is the feature vector associated with \hat{ρ}_{i,j}^{max}.
2. Determine if the feature vector, \hat{f}_{i,j}^{test}, has a time delay sufficiently close to \hat{t}_{d}_{_{u,v}}ⁱⁿⁱ by using one of the three possible decision rules of the form,

$${D}_{rule} ( {\hat{f}}_{i , j}^{test} ) = \{ \begin{matrix}{\hat{f}}_{i , j}^{ini} = {\hat{f}}_{i , j}^{test} , & if \vert {\hat{t}}_{{d}_{u , v}}^{ini} - {\hat{t}}_{{d}_{i . j}}^{test} \vert < {δ}_{rule} \\ & and {\hat{ρ}}_{i , j}^{test} > γ ; \\ {\hat{f}}_{i , j}^{ini} = 0 , & otherwise , \end{matrix} \qquad ( 13 )$$

where rule, is an index (e.g. rule=1, 2, 3) used to identify the decision rule, δᵣᵤₗₑ is the time of arrival threshold, \hat{p}_{i,j}^{test} is the peak cost function value for the feature vector tested, and γ is the peak cost function value threshold. This threshold is accompanied in the decision rules by a time of arrival threshold. Therefore, the two thresholds collectively discriminate between clutter and an object response. If \hat{f}_{i,j}ⁱⁿⁱ=0, then \hat{f}_{i,j}^{k} is removed from the feature space and Steps 1 and 2 are repeated. The procedure is terminated when \hat{f}_{i,j}ⁱⁿⁱ≠0 or if \hat{f}_{i,j}ⁱⁿⁱ=0 and all receivers in the 3×3 spatial window have been examined.

A decision is applied to \hat{f}_{i,j}^{test} in Equation (13) to determine if it has a time delay sufficiently close to \hat{t}_{d}_{_{u,v}}ⁱⁿⁱ. One physical interpretation of the criteria represented by Equation (13) is that the time of arrival of the object response received by a selected neighbouring receiver (i, j) should fall within a pre-defined interval of the time of arrival of the object response received by receiver (u, v). Moreover, a signal with a closely matching time of arrival should also have a high peak cost function value (i.e. it should exceed a pre-defined threshold). One embodiment of the decision rules is the following. Decision rule 1 is applied if receiver (i, j) is in the same column as receiver (u, v), decision rule 2 is applied if receiver (i, j) is in the same row as receiver (u, v), and decision rule 3 is applied if receiver (i, j) is diagonal to receiver (u, v).

In this embodiment, the time of arrival interval expands to accommodate the longer distance the object response travels with increased distance of the receiver under consideration from receiver (u, v). By considering the region scanned by the receivers, the maximum time delays for the 3 possible receiver configurations are calculated. In another embodiment, a technique used to predict the time-of-arrival of a tumor response may be used to determine the time delay. This technique is described in more detail in the Object Response Classification—Alternate Method Section.

After acquiring a set of initialization vectors, a check is made to ensure that each vector is non-zero (i.e. \hat{f}_{i,j}ⁱⁿⁱ≠0, for i=1, 2, 3, j=1, 2, 3). If this criterion is met, then \hat{f}_{i,j}=\hat{f}_{i,j}ⁱⁿⁱ for i=1, 2, 3, j=1, 2, 3. Thus, all object response estimates within the spatial window are identified and stored in the set {\hat{f}_{i,j}}.

Conversely, the occurrence of \hat{f}_{i,j}=0 is an indication that the initialization procedure has failed. In response, the feature space for each interior receiver is re-examined, and the feature vector with the next highest peak cost function value is selected. The entire procedure is repeated until a set of initialization points has been found. If the procedure fails to find a set of initialization points, then it is inferred that the information contained in the signals does not support the presence of an object response.

Classifying All Feature Vectors

To classify the feature vectors, the feature information is examined to determine if it originated from an object of interest. Deciding when a feature vector is related to an object response is determined by how close the feature information matches the object response information. Before classifying the feature vectors, all receivers in the n×m array are grouped column-wise. In one embodiment, the time delays associated with the classified feature vector set, {\hat{f}_{i,j}}, in the initialization window are used to compute the average time delay for the column using,

$${μ}_{j} = \frac{1}{N} {\sum }_{k = 1}^{N} {\hat{t}}_{{d}_{k}} , \qquad ( 14 )$$

where N is the number of classified feature vectors in the column. The average object response time delay for each column can be used by the decision rules for the classification procedure.

The following three step procedure can be used to classify the feature vectors in each column,
1. The feature space for receiver (i, j) is examined. The feature vector with a time delay closest to the average time delay for the column is selected and identified as f_{i,j}^{test}. That is,

\hat{f}_{i,j}^{test}=\hat{f}_{i,j}^{min} when \hat{t}_{d}_{_{i,j}}^{min}=min{|μⱼ−\hat{t}_{d}_{_{i,j}}^{k}|}

for k=1, . . . , L, (15)
where \hat{f}_{i,j}^{min} is the feature vector associated with \hat{t}_{d}_{_{i,j}}^{min}.
2. The feature vector, \hat{f}_{i,j}^{test}, is examined to determine if it has a high peak cost function, \hat{ρ}_{i,j}^{test}, and a time delay that is in close proximity to the average object response time delay for the column. These criteria can be evaluated by using the decision rule,

$${D}_{rule} ( {\hat{f}}_{i , j}^{ini} ) = \{ \begin{matrix}{\hat{f}}_{i , j} = {\hat{f}}_{i , j}^{test} , & if \vert {μ}_{rule} - {\hat{t}}_{{d}_{i , j}}^{test} \vert < {δ}_{rule} \\ & and {\hat{ρ}}_{i , j}^{test} > ϒ ; \\ {\hat{f}}_{i , j} = 0 , & otherwise ,\end{matrix} \qquad ( 16 )$$

where rule, is an index (rule=4, 5) used to identify which of the two possible rules is being applied. Rule 4 is applied when ρⱼ≠0, while rule 5 is applied when μⱼ=0.
3. If \hat{f}_{i,j}≠0, then the average object response time delay for the column is updated using (14).

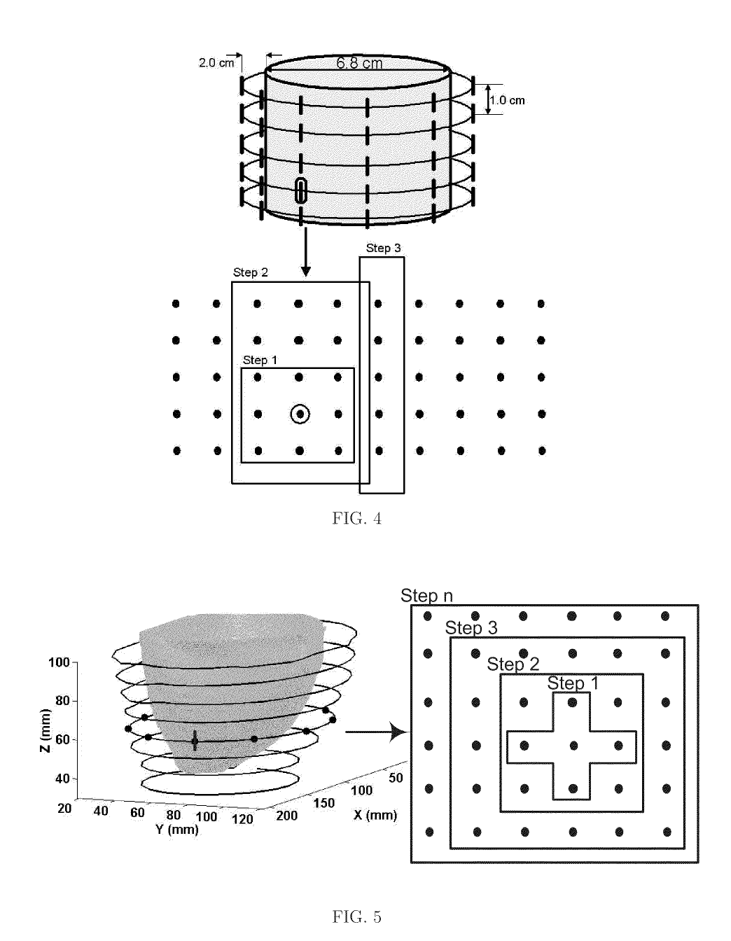

FIG. 4 illustrates the steps used to classify the vectors, according to one embodiment. When classifying the feature vectors in the j^{th} column, two cases may arise: (1) at least one feature vector in the column has been classified as an object response, indicated by μⱼ≠0, or (2) none of the feature vectors has been classified as an object response yet, which is indicated by μⱼ=0. In the first case, rule 4 is used so that μᵣᵤₗₑ is set to the column average under consideration (i.e. μ₄=μⱼ), and δᵣᵤₗₑ is set to δ₄. In the second case, rule 5 is used so that μᵣᵤₗₑ is set to the column average of the adjacent column that has already undergone the classification procedure, and δᵣᵤₗₑ is set to δ₅. The relation δ₅>δ₄ holds in order to accommodate the longer distance the object response must travel when comparing the time delay with the average time delay of the adjacent column.

In another embodiment of the method, the time delay of a candidate signal may be compared with an average time delay computed using a sub-set of the initialization window or previously classified antennas. For example, the closest 3 or 5 antennas to the candidate may be used to calculate the time delay. This technique is described in more detail in the Object Response Classification—Alternate Method Section.

The outcome of the classification process is a feature vector estimate, \hat{f}_{i,j}, associated with each receiver location (i, j) such that \hat{f}_{i,j}=0 indicates that no object response was found, and \hat{f}_{i,j}≠0 indicates that an object response was found.

To accommodate the detection of multiple objects, the classification procedure can be executed in an iterative fashion. In particular, for the next iteration, the receiver array can be searched for the next largest peak cost function value. The initialization process is then repeated. If each vector is non-zero (i.e. \hat{f}_{i,j}ⁱⁿⁱ≠0, for i=1, 2, 3, j=1, 2, 3), then the initialization vectors are examined to determine if they have already been classified. If the vectors have already been classified, then the initialization process is repeated for the next highest peak cost function value. Otherwise, the classification process is repeated. The classification process is terminated once all of the initialization vectors are 0.

Object Response Classification—Alternate Method for Step 120

The object response classification process for step 120 described in the previous section is suited for simple cases where the tumor is observed at a collection of antennas and clutter is not as significant. A major challenge for this method is to detect a tumor response that is obscured by a significant amount of clutter (or signals arising from scattering mechanisms other than the tumor). The challenge arises primarily due to the difficulty in discriminating between a tumor response and the response due to a non-tumor scattering mechanism. This ambiguity may lead to false identification of the tumor response. This may result in the deterioration of the focusing performance. Variations in the breast shape and breast tissue property distribution add to the challenge of the problem. Moreover, in many realistic cases, the tumor response is observed at a limited number of antennas due to the presence of high permittivity glandular tissue. This results in a decrease in information available to localize the scatter source. These factors collectively contribute to the motivation behind the development of the alternative classification process for Step 120 described in this section. In one embodiment, step 120 may incorporate a time-of-arrival (TOA) predictor.

The TOA process is a tool that aids in distinguishing tumor responses from clutter. The key idea behind the technique is that it provides a means for finding the region of the breast that is the source of the tumor response. The technique uses 3D information observed at neighboring antennas, and may include triangulation methods similar to those used in global and sonar positioning systems. Candidate tumor responses are evaluated by comparing the TOA of the response with the predicted TOA. If reasonable agreement does not exist, then the candidate response is unlikely to originate from the same location as the tumor. For practical implementation, the TOA process assumes tumor responses are observed at only a few antennas. In addition, the TOA process integrates a priori information in an attempt to improve robustness. Specifically, information from a 3D breast surface estimate is included. Finally, the process operates iteratively, updating location estimates as tumor responses are confirmed at neighboring antennas.

Data are acquired by illuminating the breast with an ultra-wideband pulse and then recording the backscattered fields using the same antenna. The antenna is moved along a circular path enclosing the breast to form a row of antenna positions. The process is repeated at various distances between the nipple and chest wall, creating columns of data. This scan forms a synthetic array as shown in FIG. 5.

The time-of-arrival (TOA) process assumes that a tumor response has been detected at several antenna locations using the method described in the Finding a Set of Initialization Points section. However, instead of initializing the classification process with a 3×3 window containing 9 antenna elements, a cross shaped window containing just 5 elements is used. This cluster of antennas is referred to as the initialization window and is shown in FIG. 5 as step 1. Associated with each response is an estimate of the received tumor response TOA. The proposed process first uses the TOA information obtained from the initialization antennas to estimate the tumor location. Next, the classification procedure expands the spatial window by considering neighboring antennas (FIG. 5 Steps 2&3). If the predicted TOA is similar to the TOA of the detected response, then the presence of a tumor response may be inferred. Antennas with confirmed tumor responses are referred to as classified. These components of the process may work iteratively: the TOA confirmed at neighboring antennas may be used to update estimates of the tumor's 3D location; the updated estimate may then be used to predict the TOA of the tumor response at a new neighboring antenna.

A process used to estimate the tumor location is presented in the Tumor Location Estimation section. Next, incorporation of the breast surface location is proposed in the Refined Estimated Tumor Position section. Prediction of the TOA for a response at a neighboring antenna is outlined in the Predicted Tumor Response Time-Of-Arrival section. Collectively, these processes may be used as an alternative method for Step 120 for classifying the object response described in the previous section.

Tumor Location Estimation

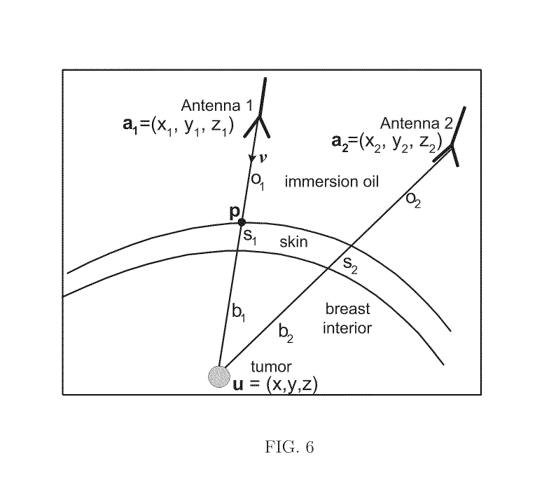

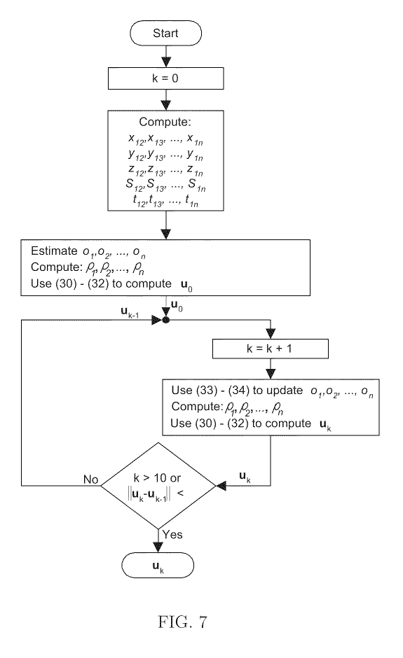

To demonstrate the theory used to develop the tumor location estimation process for Step 120, we consider two antennas. The measurement geometry of the system is shown in FIG. 6. Also shown is the direction vector ν of the line connecting the antenna to the estimated tumor position. Point p represents the intersection of this line with the breast surface. The breast is immersed in a liquid for which the relative permittivity (εₒᵢₗ) is known. A value is assumed for the unknown average relative permittivity of the breast tissue (ε_{b}). The skin thicknesses (s₁ and s₂) and antenna-to-breast surface distances (o₁ and o₂) may be estimated from the reflection data, with techniques such as peak-detection or deconvolution. The Euclidean distance from antenna 1 (a₁=(x₁, y₁, z₁)) to the tumor (u=(x, y, z)) is computed

r₁=∥u−a₁∥=\sqrt{(x−x₁)²+(y−y₁)²+(z−z₁)²} (17)

so that

r₁²=(x−x₁)²+(y−y₁)²+(z−z₁)². (18)

On the other hand, the distance may also be represented by

r₁=b₁+s₁+oᵢ (19)

where b₁ is the distance from the tumor to the inside surface of the skin, s₁ is the thickness of the skin, and o₁ is the distance from the outside surface of the skin to the antenna. Likewise, for antenna 2 (where a₂=(x₂, y₂, z₂))

r₂²=(x−x₂)²+(y−y₂)²+(z−z₂)² (20)

and

r₂=b₂+s₂+o₂=r₁+Δb₂+Δs₂+Δo₂ (21)

where Δb₂, Δs₂, and Δo₂ are the differences in distances between the first and second antennas for the breast tissue, the skin thickness, and the distance from the outside surface of the skin to the antenna, respectively. For this study we assume that the difference in skin thickness is negligible so that Δs₂≈0. Using (21), we may also compute

$$\begin{matrix}{r}_{2}^{2} = {( {r}_{1} + Δ {b}_{2} + Δ {s}_{2} + Δ {o}_{2} )}^{2} \\ = {r}_{1}^{2} + 2 ( Δ {b}_{2} + Δ {o}_{2} ) + {( Δ {b}_{2} + Δ {o}_{2} )}^{2} .\end{matrix} \qquad ( 22 )$$

Substituting (18) into (22), and equating the result to (20) yields the following equation after simplification

$$x ( {x}_{12} ) + y ( {y}_{12} ) + z ( {z}_{12} ) - {r}_{1} {ρ}_{2} = \frac{1}{2} ( {ρ}_{2}^{2} + {S}_{12} ) \\ where \\ {x}_{12} = {x}_{1} - {x}_{2} , \\ {y}_{12} = {y}_{1} - {y}_{2} , \\ {z}_{12} = {z}_{1} - {z}_{2} , \\ {S}_{12} = ( {x}_{1}^{2} + {y}_{1}^{2} + {z}_{1}^{2} ) - ( {x}_{2}^{2} + {y}_{2}^{2} + {z}_{2}^{2} ) \\ and \\ {ρ}_{2} = Δ {b}_{2} + Δ {s}_{2} + Δ {o}_{2} . \qquad ( 23 )$$

Expressions for b₂ and o₂ are developed using the tumor response TOA. The difference in the TOA estimate of the tumor response received by antennas 1 (TOA₁) and 2 (TOA₂) is given by

t₁₂=TOA₂−TOA₁. (24)

Alternatively, (24) may be expressed as,

t₁₂=t_{b}+tₛ+tₒᵢₗ (25)

where t_{b}, tₛ, and tₒᵢₗ are the time differences due to the different propagation path lengths through the breast tissue, the skin, and the oil respectively. We note that the times (t₁₂,t_{b},tₛ,tₒᵢₗ) are related to round trip distances. The assumption that Δs₂=0 implies that tₛ≈0, so that (25) may be re-written as

t_{b}=t₁₂−tₒᵢₗ. (26)

The distance from each antenna to the surface of the breast may be used to estimate

$$\begin{matrix}{t}_{oil} = \frac{2 Δ {o}_{2}}{{ν}_{oil}} \\ = \frac{2 ( {o}_{2} - {o}_{1} )}{{ν}_{oil}}\end{matrix} \qquad ( 27 )$$

where νₒᵢₗ=c/\sqrt{εₒᵢₗ}, c is the speed of light, and εₒᵢₗ is the known relative permittivity of the immersion liquid. Substituting (27) into (26) leads to

$$Δ {b}_{2} = \frac{{ν}_{2}}{2} ( {t}_{12} - \frac{2 Δ {o}_{2}}{{ν}_{oil}} ) \qquad ( 28 )$$

where ν_{b}=c/\sqrt{ε_{b}}, and ε_{b} is the assumed relative permittivity of the breast tissue. Finally, substituting (28) into (23) results in a linear equation with four unknowns (i.e. x, y, z, and r₁).

The preceding argument may be extended to the n^{th} antenna to generalize (23) with

$$x ( {x}_{1 n} ) + y ( {y}_{1 n} ) + z ( {z}_{1 n} ) - {r}_{1} {ρ}_{n} = \frac{1}{2} ( {ρ}_{n}^{2} + {S}_{1 n} ) . \qquad ( 29 )$$

Hence, for n antennas (where n≧4), (29) is used to form a system of n linear equations expressed in matrix form as

$$[ \begin{matrix}{x}_{12} & {y}_{12} & {z}_{12} & - {ρ}_{2} \\ {x}_{13} & {y}_{13} & {z}_{13} & - {ρ}_{3} \\ ⋮ & ⋮ & ⋮ & ⋮ \\ {x}_{1 n} & {y}_{1 n} & {z}_{1 n} & - {ρ}_{n}\end{matrix} ] [ \begin{matrix}x \\ y \\ z \\ {r}_{1}\end{matrix} ] = [ \begin{matrix}\frac{1}{2} ( {ρ}_{2}^{2} + {S}_{12} ) \\ \frac{1}{2} ( {ρ}_{3}^{2} + {S}_{13} ) \\ ⋮ \\ \frac{1}{2} ( {ρ}_{n}^{2} + {S}_{1 n} )\end{matrix} ] \qquad ( 30 )$$

which may be written more compactly as

Aθ=b. (31)

Hence,

θ=(A^{T}A)⁻¹A^{T}b (32)

provided that A is not singular. We observe that (32) has an exact solution when n=4. Otherwise, the over-determined system of equations may be used to find an analytic solution (\hat{θ}=(\hat{x}, ŷ, \hat{z}, \hat{r}₁)) approximated in a least squares sense.

In one embodiment, singularities may be avoided and the robustness of the process may be improved by decreasing the condition number of A. Singularities may arise when multiple antennas provide redundant information. For example, two antennas that are equidistant from the tumor may have equivalent differences in TOAs (TOAs). Likewise, A is ill-conditioned if multiple antennas have similar TOAs. One strategy that may be implemented to improve the robustness of the solution is to sort the antennas in ascending order according to their associated TOAs. When constructing (30), the antenna with the smallest TOA (i.e. closest to the tumor) is selected as antenna 1, while the antenna with the largest TOA (i.e. furthest from the tumor) is selected as the n^{th} antenna. Moreover, before (32) is computed, the condition number for A is checked. A large condition number suggests the occurrence of multiple antennas with similar TOAs. Antennas providing redundant information may then be removed from the array before constructing (30).

Refined Estimated Tumor Position

The estimation of o₁ and o₂ with single reflected signals does not consider the position of the tumor. Instead, each measurement represents the closest point on the breast surface to the respective antenna. This may lead to errors in the estimation of the antenna-to-tumor propagation path length. In order to improve the accuracy of the measurement, information from the 3D breast surface is incorporated into the process. This surface information may be estimated from the microwave signals with various estimation processes, or measured with an alternative technique using lasers. Referring to FIG. 6, a vector parametric equation of the line connecting the antenna to the estimated tumor position is used to evaluate the location on the breast surface using

p=a₁−tν (33)

where t is a scalar such that tε[0, 1], and ν is the direction vector of the line. We observe that t=0 corresponds to the position on the line at the antenna, while t=1 represents the position on the line at the estimated tumor location. For antenna 1, the position on the line at the breast surface is determined by starting at the antenna (i.e. t=0), and then moving along the line using (33) by increasing t until the point of intersection with the surface of the breast is reached. This value, p is used to update the antenna-to-breast surface distance using

o₁=∥a₁−p∥. (34)

However, an estimate of the tumor position must be available in order to construct (34). To remedy this problem, the process computes an initial estimate of the tumor location using the antenna-to-breast surface distance data computed with single reflected signals. The initial estimate, û₀, is used by (33)-(34) to refine the difference in antenna-to-breast surface distance information (i.e. oᵢ)). The refined information is, in turn, incorporated into (30) to improve the precision of the tumor position estimate. These steps are repeated iteratively to refine the estimation. A flow diagram of the process is shown in FIG. 7. For the first iteration, the antenna-to-surface distance estimates with single reflected signals are used to evaluate an initial estimate of the tumors position. This position is used to update the antenna-to surface distance estimates using the 3-D breast surface. Use of this information leads to a refined estimation of the tumor position.

Predicted Tumor Response Time-of-Arrival

Once an estimate of the tumor response is obtained, additional antennas may then be used to evaluate (32). We consider the unclassified i^{th} antenna that borders the k×m classified array where k is the number of antennas in the row that have been classified and m is the number of antennas in the column that have been classified such that k×m≧5. The estimated tumor position and the TOA from a classified antenna are used to determine if the i^{th} antenna has received a tumor response. The change in TOA between antenna 1 and antenna i is obtained by re-arranging the result when (28) is substituted into (21) and is given by

$${t}_{1 i} = 2 Δ {o}_{i} ( \frac{1}{{ν}_{oil}} - \frac{1}{{ν}_{b}} ) + \frac{2 ( {r}_{1} - {r}_{i} )}{{ν}_{b}} \qquad ( 35 )$$

where the estimated tumor position û=(\hat{x},ŷ,\hat{z}) is substituted into (17) so that rᵢ=\sqrt{(\hat{x}−xᵢ)²+(ŷ−yᵢ)²+(\hat{z}−zᵢ)²}). When dealing with discrete-time data, the quantity computed in (35) may be converted to a discrete value (i.e. number of time-samples) using

$$Δ T O {A}_{1 i} = ⌊ \frac{{t}_{1 i}}{Δ t} ⌋ \qquad ( 36 )$$

where └•┘ extracts the integer part of (35), and Δt is the sample interval time. Finally, the predicted TOA of the tumor response received by the i^{th} antenna is computed by re-arranging (24) to yield

TOAᵢ=TOA₁−ΔTOA₁ᵢ. (37)

A close match between TOA; and the TOA estimated from the response received at the i^{th} antenna infers that the antenna has received a tumor response. To provide additional support to determine if the response is associated with a tumor, the peak cost function value is also examined. This allows the information contained in the response received to be evaluated. Recall that the peak value of the cost function (\hat{ρ}_{i,j}^{k}) described in the Extracting Object Features—Step 110 section provides a measure of the match between information contained in the signal and a tumor response model. That is, a high cost function value indicates that the response received has a high level of target response information. This signal information, combined with the TOA information, leads to the classification of the feature vector.

Reconstruction of Object Estimate—Step 130

At the termination of Step 120, the set of receiver feature vectors associated with an object response is identified. Next, the elements (i.e., A, γ, t_{d}, and α) of each object classified feature vector are substituted into Equation (2), where A is a time independent scaling factor, t_{α}(n) is an object reference response, t_{d} is the time delay between the actual object response and the reference signal, and γ is a damping factor. This results in a set of reconstructed estimates of the object response, i.e., one reconstructed object response estimate for each object classified feature vector. The set of reconstructed object response estimates is input to an image focusing process. In essence, the reconstruction of the object estimate transforms the feature vectors into a format necessary for the image focusing that can be used to create an image, allowing a clutter reduction process to interface with the image focusing process.

Improved Estimate of Object Response—Step 140

Optional Step 140 may be used to refine the object response estimate. In this step 140, the object estimate and signal data are transformed to the frequency domain. Thus, step 140 provides a new parameter space from which to extract relevant features from the signals. In particular, poles corresponding to clutter are identified. Effective modeling of the clutter provides a means of identifying and segregating the clutter from the object response. This, in turn, allows the clutter estimate to be removed from the total signal data. The resulting residual data set is a refinement of the original object estimate.

The object estimate computed by the feature extraction/object classification processes for each signal are incorporated into a frequency domain object model. Hence, this instance of the object model presented represents an enhancement of the object model discussed above.

Pre-conditioning processes are first applied to the signal measurements to remove the early time scattered fields, which contain the receiver response and any reflections from surfaces that may be present at the interface between the receiver and the environment. The resulting data are then transformed to the frequency domain. Thus,

X(ω)=T(ω)+C(ω)+W(ω) (38)

where T(ω), C(ω), and W(ω) are the Fourier transforms of the object response t(t), the clutter c(t) and the noise w(t) identified in Equation (1). An iterative signal-processing technique (or object response enhancement process) may then be applied to the data.

One objective of the process is to identify and remove the clutter contributions in (38). The process models the frequency domain response of the clutter contributions in the signals as a summation of complex poles (or modes) based on a singularity expansion method (SEM) given by

$$C ( ω ) = {\sum }_{m = 1}^{P} {A}_{m} {e}^{- ω ( {α}_{m} + j {t}_{m} )} \qquad ( 39 )$$

where P is the number of poles needed to model the clutter, Aₘ is strength of the m^{th} pole, αₘ is the damping factor of the m^{th} pole, and tₘ is the time delay of the m^{th} pole.

The feature vector, \hat{f}_{i,j}, that was classified as associated with an object response estimate in step 120 of FIG. 1, is used to reconstruct an estimate of the object response given by,

$$t ( n ) = \{ \begin{matrix} {At}_{α} ( n - {t}_{d} ) , & n = 0 , … , {t}_{d} \\ A {e}^{- n γ} {t}_{α} ( n - {t}_{d} ) , & n = {t}_{d} , … , N - 1\end{matrix} \qquad ( 40 )$$

The time-domain object response estimate \hat{t}(n) is transformed to the frequency domain to form the data set \hat{T}ᵣ(ω). This signal is embedded in a parametric function used to model the frequency domain object response and given by,

T(ω)=Aᵣe^{-ω(γ}^{ᵣ}^{+jt}^{ᵣ}⁾\hat{T}ᵣ(ω), (41)

where Aᵣ is a frequency independent parameter that accommodates amplitude variations between the object estimate \hat{T}ᵣ(ω) and the actual object response, γᵣ is a damping factor that takes into account the frequency-dependent losses clue to the propagation of the signal through the environment, such as tissues, and tᵣ is the time delay that accounts for the differences in location of the actual object response and estimate. Equation (41) can be interpreted as being a refinement, of the initial object response derived from the classification process. More importantly, the object estimate \hat{T}ᵣ(ω) provides a starting estimate of T(ω).

If \hat{f}_{i,j}=0, then this implies that the pattern classification process did not detect an object response in the pre-conditioned signal. The object response estimate enhancement process responds by setting the object response estimate \hat{T}(ω)=0, and is then applied to the next pre-conditioned signal in the array.

Substituting the clutter model (39) and the object model (41) into Equation (38) leads to

$$X ( ω ) = {A}_{r} {e}^{- ω ( {γ}_{r} + j {t}_{r} )} {\hat{T}}_{r} ( ω ) + {\sum }_{m = 1}^{P} {A}_{m} {e}^{- ω ( {α}_{m} + j {t}_{m} )} + W ( ω ) . \qquad ( 42 )$$

One goal of the object response estimate enhancement process is to solve for the unknown parameters in Equation (42). Since Equation (42) is non-linear, an iterative approach is used to find a solution to this estimation problem. Specifically, the method iteratively identifies and extracts the complex poles from the signal data that are associated with the clutter. During each iteration, the extracted poles are used to construct an estimate of the clutter. The estimate of the clutter is then removed from the signal data, resulting in a residue data set. The object response model given by (41) is fitted to the residue data in order to form an updated estimate the model parameters (Aᵣ, tᵣ, γᵣ), which is used by the next iteration. Thus, using this approach, all parameters in Equation (42) may be approximated.

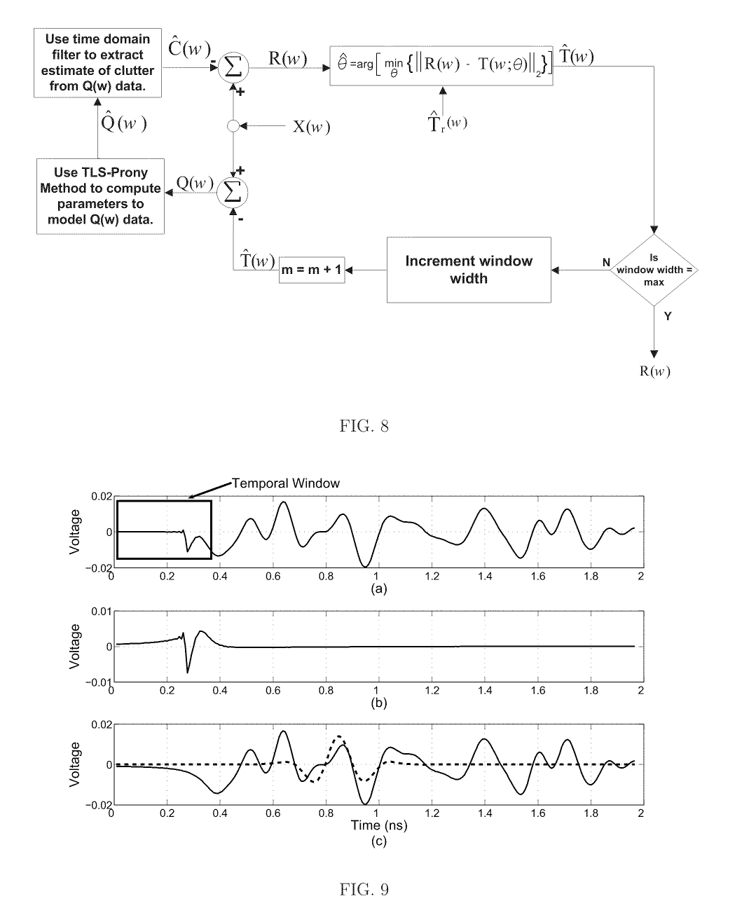

The process that is used to achieve this goal is shown in FIG. 8. The present embodiments may be used in various contexts. For example, the present embodiments may provide an alternative to or an improvement of certain land mine detection techniques described in, e.g., van der Merwe, et al., “A Novel Signal Processing Technique for Clutter Reduction in GPR Measurements of Small, Shallow Land Mines,” IEEE Transactions on Geosciences and Remote Sensing, Vol. 38, No. 6 (Nov. 2000), which is incorporated herein by reference in its entirety. The signal data, X(ω), and the object response estimate, \hat{T}ᵣ(ω), from the feature extraction/object response classification process are input to the program. The program starts by forming the data.

Q(ω)=X(ω)−\hat{T}(ω), (43)

where \hat{T}(ω) is an estimate of the object response from the previous iteration. That is, \hat{T}ᵣ(ω) and the parameter estimates, (Aᵣ, tᵣ, γᵣ), from the previous iteration are used to compute \hat{T}(ω). For the first iteration \hat{T}(ω)=0, since the model parameters of (41) has not yet been computed. The resulting data are modeled as a summation of complex poles given by,

$$Q ( ω ) = {\sum }_{k = 1}^{M} {A}_{k} {e}^{- ω ( {α}_{k} + j {t}_{k} )} \qquad ( 44 )$$

where M is the number of complex poles needed to model Q(ω), Aₖ is the strength of the k^{th} pole, αₖ is the damping factor of the k^{th} pole, and tₖ is the time delay of the k^{th} pole.

Two challenges in computing Q(ω) are determining the unknown parameters, and finding the number of modes, M. The unknown parameters of Equation (44) are solved using a separation of parameters approach known as the total least squares (TLS) Prony method. The TLS-Prony method adapted for this application is described in more detail in the Description of the Total Least Squares—Prony Method section.

A challenge for this problem is estimating the number of modes, M, contained in the signal. When damped signals are considered, information theoretic techniques, and Bayesian MMSE estimators are typically unsuccessful in estimating this parameter. However, due to the mathematical similarity between this problem and the blind channel estimation problem encountered by communication systems, a subspace method may be successful in estimating this parameter. The subspace method adapted for this application is described in more detail in the Estimating the Number of Signal Modes in a Waveform using a Subspace Decomposition Technique section.

The TLS-Prony method applied to (44) extracts the M poles from Q(ω) forming the set of triples {(Âₖ, \hat{α}ₖ, \hat{t}ₖ)}ₖ₌₀^{M-1}. To permit the separation of the clutter poles from signal (object) poles, a temporal window is defined as,

W=tₛₜₒₚ−tₛₜₐᵣₜ, (45)

where tₛₜₐᵣₜ is fixed at; 0 (i.e. tₛₜₐᵣₜ=0), and tₛₜₒₚ is incrementally increased. This increases the duration of the window with each successive iteration of the process. It is assumed that the poles contained within the temporal window are associated with clutter. The application of the temporal window to this set of extracted poles forms a set of clutter poles given by {(Âₘ,\hat{α}ₘ,\hat{t}ₘ)}=ₘ₌ₜ_{ₛₜₐᵣₜ}^{t}^{ₛₜₒₚ} with {(Âₘ,\hat{α}ₘ,\hat{t}ₘ)}ₘ₌ₜ_{ₛₜₐᵣₜ}^{t}^{ₛₜₒₚ}⊂{(Âₖ,\hat{α}ₖ,\hat{t}ₖ)}ₖ₌₀^{M-1}. This operation is expressed mathematically as,

(Âₖ,\hat{α}ₖ,\hat{t}ₖ)ε{(Âₘ,\hat{α}ₘ,\hat{t}ₘ)}ₘ₌ₜ_{ₛₜₐᵣₜ}^{t}^{ₛₜₒₚ} when \hat{t}ₖε[tₛₜₐᵣₜ,tₛₜₒₚ], for k=0, . . . , M−1. (46)

This set of clutter poles is used to construct an estimate of the clutter,

$$\hat{C} ( ω ) = {\sum }_{k = {t}_{start}}^{{t}_{stop}} {\hat{A}}_{k} {e}^{- ω ( {\hat{α}}_{k} + j {\hat{t}}_{k} )} \qquad ( 47 )$$

where Âₖ, \hat{α}ₖ, and \hat{t}ₖ are the estimates of the parameters associated with the k^{th} pole within the selected temporal window.

The first few high energy poles are typically associated with any interface response. That is, the error in the interface response estimation technique leads to incomplete removal of the interface response during the pre-conditioning step of the signal. Hence, for the first iteration, the duration of the temporal window is short, so that the first few high energy clutter poles associated with the interface response are extracted.

The residue data, R(ω), are then obtained by subtracting the current clutter estimate from the pre-conditioned signal data,

R(ω)=X(ω)−Ĉ(ω). (48)

The object model given by (41) is then fitted to the residue in a least squares sense by,

$${\hat{θ}}_{LS} = {arg [ {min}_{θ} ‖ R ( ω ) - {A}_{r} {e}^{- ω ( {γ}_{r} + j {t}_{r} )} {\hat{T}}_{r} ( ω ) ) ‖}_{2} ] . \qquad ( 49 )$$

Finally, the estimates, \hat{θ}_{LS}=[Âᵣ \hat{γ}ᵣ \hat{t}ᵣ]^{T} are substituted into (41) to construct an estimate of the object response \hat{T}(ω). This completes one iteration of the process.

For the next iteration, the updated object response estimate \hat{T}(ω) is substituted back into (43) to obtain a new data set Q(ω). With each successive iteration of the process, the temporal window expands to increase the number of clutter poles extracted using (46). The increase in the number of clutter poles identified leads to progressively more accurate estimates of the clutter. More accurate clutter estimates, in turn, lead to more accurate object response estimates from (49).

If the process is successful, it terminates with the majority of the clutter poles identified and separated from the other signal poles. This results in an accurate estimate of the clutter. Identification of the clutter contributions allows for the removal of the clutter estimate from the signal data. Once the clutter has been removed, the remaining data (or residual data R(ω)) are dominated by the object response. The residual data from several receiver locations are then focused by an image processing method to produce an image that implies the possible presence and location of the object in 3-dimensions.

In one embodiment, the technique described above can be adapted from a process developed for a ground-penetrating radar (GPR) application used in the detection of shallow (surface or near surface) buried ordnance. The shallow mine problem implies that the location of the buried target (or mine) is assumed to be within a very limited range near the ground-surface interface. As a consequence, the range in values that tᵣ in (41) can assume is contained within a narrow temporal range, which is unrealistic for some applications. To complicate matters, (41) are non-convex so that (49) does not have a closed form solution. Since (49) has multiple local minima, the frequency domain object estimate \hat{T}ᵣ(ω) derived from the pattern classification procedure serves the valuable purpose of providing an initial estimate of the unknown model parameters. It is assumed that \hat{T}ᵣ(ω) is close to (i.e. in the neighborhood of) T(ω). Therefore, for the first iteration of the process, the estimates are initially assumed to be \hat{θ}_{LS}=[Âᵣ=1 \hat{γ}ᵣ=0 \hat{t}ᵣ=0]^{T}. From this starting point, the basic idea is that the estimates should, in principle, converge to their true values when the process has terminated.

A second modification to the process is related to the initial duration of the temporal window used to extract the clutter poles. Since it is assumed that \hat{T}ᵣ(ω) is in the neighborhood of \hat{T}(ω), then the temporal location of the object response within the signal is approximately known. Hence, this a priori information is used to adjust the duration of the temporal window for the first iteration of the program.

The process zeros the parameters (which is equivalent to zeroing the signal) if it is unable to estimate the model parameters. The process assumes that estimated values outside the permissible range imply that the information contained in the signal does not support the existence of a object response. Therefore, the object response enhancement process serves to validate the estimates provided by the feature extraction/classification process.

Application of the Process to Radar-Based Imaging Methods

In one embodiment of the signal processing method, image data from a microwave-based imaging system can be processed to remove clutter from the image. Specifically, the microwave-based imaging system can include a tissue sensing adaptive radar (TSAR) system. X-ray mammography is presently the leading imaging method used for breast cancer screening. The limitations of this technique have generated interest in complementary imaging modalities. Several microwave imaging techniques for breast cancer detection have recently been developed, including techniques based on variations in the dielectric properties of tissues.

Previously, the dielectric property contrast between healthy and diseased tissues was thought to be as high as 5:1. However, recent studies reporting large-scale measurements of excised breast tissues show variations in the properties of normal tissues that appear to be related to the proportion of adipose content. In particular, the distribution and proportion of adipose content of healthy breast tissue can impact the performance of microwave imaging, as the composition of the breast may range from fatty (high adipose content) to extremely dense (low adipose content), resulting in a variety of imaging challenges. A method capable of dealing with the complexity of both the tissue properties and breast tissue composition may be advantageous. Radar-based microwave imaging methods such as TSAR can detect the presence of significant backscattered energy arising from tissues with high dielectric properties (e.g. fibroglandular tissue and tumors).

Radar-based methods may use an antenna to illuminate the breast with low power, ultra-wideband pulses of microwave energy. The scattered fields are received at the same antenna, or by an array of antennas. Each received signal contains both early and late-time scattered field contributions. The antenna reverberations and reflections from the skin-breast interface (the skin response) are contained in the early-time scattered fields. The late-time fields contain backscatter from possible lesions (the tumor response) and clutter. In this context, clutter is defined as signals arising from scattering mechanisms other than the tumor. Effective suppression of the clutter is required in order for the radar based methods to successfully detect and localize small tumors.

TSAR can use an approach to reducing early time artifacts. Namely, an adaptive filter combined with other statistical signal processing methods can be used to remove an estimate of the skin response from each signal as part of the pre-processing.

In one embodiment of the signal processing method, a very simple image focusing process is used. To maintain this simplicity, clutter suppression in the pre-processed signals may be required in order to detect and localize small tumors. Methods can be used to estimate the tumor response in the pre-processed signals, and the 3-D information collected at an array of antennas may be used to classify and identify responses, thereby improving discrimination between clutter and tumor responses. The process may also be incorporated with a process that models both tumor and clutter in order to further enhance clutter suppression.

### APPLICATION EXAMPLES

### Example of the Application of the Process to Radar-Based Imaging Methods

To test the processes, they may be applied to data generated with FDTD simulations and experimental data from phantoms. In both cases, the TSAR, signals may be pre-conditioned by removing the antenna, reverberations and the estimated skin response using, for example, a Woody-RLS skin-subtraction process.

When collecting data, reflections are recorded as a suitable antenna is scanned around the object of interest that contains the target (e.g. the breast containing the tumor). For

TABLE 1
Estimation vectors derived from the data contained in each
temporal window for the signal shown in FIG. 3(a).

| Window No. | Â | \hat{r} | \hat{t}_{d} | \hat{α} | \hat{ρ}ₘₐₓ |
|---|---|---|---|---|---|
| 1 | 0.05 | 0 | 34 | 21 | 0.00 |
| 2 | 1.07 | 0.0047 | 57 | 12 | 0.72 |
| 3 | 1.04 | 0.0081 | 80 | 1 | 0.85 |
| 4 | 0.98 | 0.0052 | 104 | 4 | 0.98 |
| 5 | 0.27 | 0.01 | 136 | 1 | 0.49 |
| 6 | 0.14 | 0.0 | 160 | 21 | 0.00 |
| 7 | 0.13 | 0.0 | 194 | 21 | 0.00 |

example, this may be a resistively loaded dipole, a TEM horn, Vivaldi, or other ultra-wideband antenna. For initial testing of processes, a resistively loaded dipole antenna may be scanned to 50 locations (5×10 antenna array) encircling a cylindrical breast model shown in FIG. 4. Two cases were examined: (1) a breast model containing a single target, and (2) containing multiple targets.

First, for the single target case, a spherical target ranging in diameter from 3 to 6-mm was embedded in the heterogeneous breast tissue of a 6.8-cm diameter cylindrical breast model with 2-mm thick skin. The electrical properties of the target (εᵣ=50, σ=4 S/m) were the same in all simulations. In one embodiment, breast tissue was characterized using three broad categories depending on the proportion of adipose tissue. For example, it may be assumed that the breast tissue was predominantly fat (i.e. 85-100% adipose tissue). Hence, the heterogeneity of the breast tissue was simulated using 4-mm cubes which have random variations of up to +/−10% in the electrical properties of fatty breast tissue values (εᵣ=8.6-9.4, σ=0.36-0.44 S/m). The electrical properties of the breast model and the immersion liquid were constant over the frequency band used for the simulations.

Three different reference sets were created to test the detection of targets in the presence of variations between the targets and references. Reference set Ref₁ contained four reference responses derived from four different diameter spheres (6, 5, 4, and 3-mm) with the same electrical properties as the target. Reference set Ref₂ contained a single reference response derived from a sphere with a diameter of 4-mm and the same electrical properties as the target. Reference set Ref₃ contained a single reference response derived from a sphere with a diameter of 4-mm and εᵣ=55, σ=5.5 S/m.

Second, reference set Ref₃ was used to locate two spherical targets located at different 3-D locations within the cylindrical breast model. The first target had a 4-mm diameter target with εᵣ=60, σ=5.0 S/m, while the second target had a 5-mm diameter with εᵣ=50, σ=4.0 S/m. The targets were separated by 30 mm. Breast tissue heterogeneity was simulated using the same method described for case 1.

An experimental system is described in detail in J. M. Sill and E. C Fear, “Tissue Sensing Adaptive Radar for Breast Cancer Detection and Experimental Investigation of Simple Tumor Models,” IEEE Trans. Microwave Theory Tech., vol. 53, pp. 3312-3319, Nov. 2005, which is incorporated in its entirety herein by reference. The system consists of a Plexiglas tank, immersion liquid, ground plane, antenna, and a breast phantom. The antenna, used to illuminate the breast model was a resistively loaded Wu-King monopole. The monopole antenna was secured in a fixed position on the ground plane that was mounted on top of the tank. The antenna's fixed position in the ground plane does not permit scanning of the antenna around the model. However, the breast model may rotate, permitting a simple scan of the model. This case was included to test the process with simple experimental data, rather than explore the detection capabilities in a variety of scenarios.

Windowed Estimates Algorithm—Step 110

To demonstrate the windowed estimates process, TSAR, data are obtained using a simple cylindrical model. The model is illuminated and reflections are recorded as the antenna is scanned to 10 locations in each of 5 rows. Spherical tumors with diameters ranging from 3 to 6-mm are inserted into the cylindrical breast model. A simulation is also performed without a tumor present. In one embodiment, the data are pre-processed

TABLE 2
Performance of the estimator in response to various target diameters.
Data are acquired with a 50 element cylindrical synthetic antenna array
for each tumor size. The averages are computed over the 50 signals.

| | Ref₁ | | | Ref₂ | | | Ref₃ | | |
|---|---|---|---|---|---|---|---|---|---|
| | | | Dist. | | | Dist. | | | Dist. |
| | | | error | | | error | | | error |
| | ρₘₐₓ | r_{t\hat{t}} | (mm) | ρₘₐₓ | r_{t\hat{t}} | (mm) | ρₘₐₓ | r_{t\hat{t}} | (mm) |
| 3 | 0.84 | 0.94 | 0.35 | 0.83 | 0.96 | 0.46 | 0.80 | 0.91 | 0.11 |
| 4 | 0.86 | 0.95 | 0.22 | 0.84 | 0.94 | 0.13 | 0.81 | 0.90 | 0.25 |
| 5 | 0.87 | 0.92 | 0.18 | 0.87 | 0.94 | −0.05 | 0.81 | 0.84 | 0.12 |
| 6 | 0.92 | 0.96 | −0.06 | 0.89 | 0.91 | −0.10 | 0.84 | 0.84 | −0.70 |

to remove the early time scattered fields. The sampling interval of the signal is 0.48 ps. The actual tumor responses are calculated by subtracting the tumor-free response from each response computed with a tumor present. Since the signal is down-sampled, N is 256. For this example, the number of signals, nᵣ, in the reference set is 1.

FIG. 3(a) shows how the process segments the pre-processed signal received at a selected antenna into multiple overlapping temporal windows, for example, described in D. J. Kurrant, E. C. Fear, and D. T. Westwick, “Tumor Estimation in Tissue Sensing Adaptive Radar (TSAR) Signals,” in IEEE Proc. CCECE, pp. 860-863, 2007, which is incorporated herein by reference in its entirety. The MAP given by Equation (10) is applied to each window. Thus, for each window, the MAP iteratively selects a reference signal and evaluates values of the model parameters that maximize the cost function using the line search method described in the Extracting Object Features—Step 110 section. The tumor-to-clutter (TCR) ratio within the window varies. In some cases the signal is predominately clutter (leading to a very low TCR), while in other cases the signal contained in the window is dominated by the tumor response. For the windows formed in this example, the TCR ranges

TABLE 3
Proportion of the antennas of the 50 element synthetic antenna array
that detect a target response as the target diameter decreases.

| | Ref₁ | Ref₂ | Ref₃ | 2 tumor case |
|---|---|---|---|---|
| Tumor | Responses | Responses | Responses | Responses |
| Size (mm) | Detected (%) | Detected (%) | Detected (%) | Detected (%) |
| 3 | 80 | 76 | 74 | — |
| 4 | 84 | 82 | 70 | 28 |
| 5 | 92 | 86 | 82 | 48 |
| 6 | 98 | 98 | 94 | — |

from −2.08 dB to −17.29 dB. Examples of estimation vectors computed for each temporal window are shown in Table 1.

It is observed that the feature vector associated with the fourth window contains the highest peak cost function value, indicating that the tumor estimate closely matches the signal contained in the fourth window. This, in turn, implies that the estimated tumor response can be constructed using the tumor response model given by (2) with the function parameter estimates from the fourth feature vector. This tumor estimate may be superimposed onto the actual tumor response in FIG. 3(b), demonstrating that a good agreement is achieved. Typically, high cost function values are obtained for more than one window. Hence, ambiguity exists as to which one of the feature vectors is likely to correspond to the actual tumor. The pattern classification process described herein may resolve this ambiguity.

Next, the impact of the reference set on the results are investigated. Signals collected from breast models containing tumors of different sizes are processed with the windowed estimates method and the reference sets described above. The performance of the feature extraction process and the classification process for the simulated data may be evaluated by inspecting the peak value of the cost function (ρₘₐₓ), the cross-correlation between the actual target response and the target estimate (rₜᵢ), and the distance error between the actual target response and the location of the estimated target. The peak cost function is a measure of how closely the estimate matches the signal contained in the sliding temporal window. The results for simulated data are summarized in Table 2. The average peak cost function value and the average cross-correlation coefficient were approximately the same for all tumor sizes examined. The accuracy of the target estimates in terms of the cross-correlation coefficient and the distance error was not significantly different for the three reference sets used. Table 2 also demonstrates that the distance error for each of the targets was small and was not influenced significantly by the reference set used. Therefore, the process is robust to variations between the target and reference. The 4-mm target in the multiple target case had ρₘₐₓ=0.87, rₜᵢ=0.84, and distance error=−0.25 mm, while the 5-mm target had ρₘₐₓ=0.86, rₜᵢ=0.89, and distance error=0.04 mm. The results are comparable with the single target case, indicating that the process is capable of detecting multiple scattering objects.

The number of responses out of a total of 50 signals detected is indicated in Table 3. As expected, regardless of the reference set used, the number of signals detected was lowest when detecting the 3-mm target and progressively improved as the size of the tumor increased. Typically, received signals from the 3-mm tumor had the lowest tumor-to-clutter ratio, leading to a fewer number of tumor responses detected. The focusing process used the tumor response estimates from several antennas. Hence, a goal was not to detect the presence of the tumor response with a single antenna. Instead, since the focusing process constructs an image from data at several antennas, it was more important that accurate estimation of the tumor response be provided for those signals where the tumor was detected. The number of tumor responses detected was lower when using Ref₃ compared to Ref₁. For some of the signals, the use of Ref₃ lead to a peak cost function value, ρₘₐₓ, below the threshold used by the decision rules. This, in turn, resulted in a decreased number of tumor responses detected.

For the multiple targets, the target responses were detected by 76% of the antennas (48% of the 5-mm target response are detected and 28% of the 4-mm target responses are

TABLE 4
The signal-to-clutter ratio of the imaging in response to
various target diameters without and then with the tumor
estimation technique using different reference sets.

| Size | | | | |
|---|---|---|---|---|
| (mm) | without | Ref₁ | Ref₂ | Ref₃ |
| 6 | 5.8 | 11.07 | 11.64 | 4.87 |
| 5 | 4.04 | 9.85 | 10.1 | 6.88 |
| 4 | 5.04 | 8.81 | 7.04 | 4.76 |
| 3 | Not Found | 6.33 | 5.09 | 5.05 |

detected) which was lower than the proportion of responses detected for the single target case. This was primarily due to the interaction between the two tumor responses that occurred in many of the signals received.

To further investigate the impact of the process, images were formulated by synthetically focusing the resulting tumor response estimates. The resulting reconstructed image was not perfectly round since the process did not interpolate the information between the antennas. The images were evaluated quantitatively with the signal-to-clutter ratio given by,

SCR_{I}=10 log₁₀(P_{T}/P_{C}), (50)

where P_{T} and P_{C} denote the magnitude of the maximum pixel intensities corresponding to the tumor and clutter, respectively. The maximum clutter pixel intensity corresponds to the maximum pixel value outside of the area containing the imaged tumor. Pixel intensity corresponds to energy. The tumor location error is a second measure used to evaluate the performance of the process. It is the difference between the three-dimensional location where the backscattered energy has the greatest intensity and the center of the target.

First, single target simulated data results are shown. Images of a plane orthogonal to the cylinder axis are shown for a 3-mm tumor. FIG. 13 shows an image of simple cylindrical breast model containing 3-mm tumor created with 5 rows of 10 antennas. The plane shown

TABLE 5
Performance of the imaging for the two tumor case with (after)
and without (before) the tumor estimation technique.

| | | |
|---|---|---|
| | | 3-D Location |
| Size | SCR₁ (dB) | Location error (mm) |

| (mm) | Before | After | Before | After |
|---|---|---|---|---|
| 5 | 7.19 | 7.93 | 2.23 | 2.23 |
| 4 | Not | 3.01 | Not | 1.73 |
| | Found | | Found | |

The 4-mm tumor is located in 3-D at (75, 80, 32) and the 5-mm tumor is located at (65, 60, 52)

is cut through the cylinder perpendicular to the axis. The 10 cross marks located away from the surface of the breast model represent antenna locations. The scale shows the energy level of the response. The diameter of the breast model is 6.8 cm, the center of the model is (70,70,42)-mm, and the tumor is located at (70,65,42)-mm. The image is normalized to the peak value in the data set (Max=0.0864). FIG. 13(a) shows the image without the inclusion of the tumor response estimate, while FIG. 13(b) shows the image with the inclusion of the tumor response estimation process. FIG. 13(a) demonstrates that, for the 3-mm tumor case, the image focusing process failed to detect and localize the tumor response. As demonstrated by FIG. 13(b), this problem is remedied when the focusing process is applied to the tumor response estimates. Table 4 compares the SCR_{I} before and after the application of the tumor response estimation technique, generally showing clutter reduction and achievement of tumor detection.

For all three reference sets used, the localization error was 0-mm for the 4 to 6-mm targets, and 1-mm for the 3-mm target. Without the use of the tumor estimation technique, the tumor localization error was 1-mm for the 6-mm target and O-mm for the 4 to 5-mm targets. It is observed that the four member reference set provides superior performance in terms of the degree of clutter reduction over the two single member reference sets. However, all three reference sets provide the same degree of precision in terms of localization. Table 4 indicates that the SCR_{I} is lower for reference set Ref₃. It is suggested that the less damped late-time response of the reference signal used by Ref₃ leads to the introduction of an artefact in the image. Table 4 suggests that the artefact is more pronounced for the 6-mm target.

For multiple targets, detection and localization of the target is demonstrated in FIG. 14 where the appropriate coronal sections of the breast model indicate the tumor localization and clutter distribution. The imaged targets are shown in black. The diameter of the breast model is 6.8 cm, the center of the model is (70,70,42)-mm, the 5-mm tumor is located at (65,60,52)-mm, and the 4-mm tumor is located at (75,80,32)-mm. The upper coronal section intersects with the 5-mm target while the lower coronal section intersects with the 4-mm target. FIG. 14(a) is before tumor response estimation applied, while FIG. 14(b) is after tumor response estimation applied. The SCR_{I} before and after the application of the tumor response estimate technique are shown in Table 5. Target detection and localization of the 4-mm target were not achieved without the inclusion of the tumor response estimation technique. Compared with the single target case, however, a degradation of the performance of the tumor estimation technique in terms of clutter reduction and target localization was observed. As indicated with the single-signal analysis, this was primarily due to the interaction between the two responses.

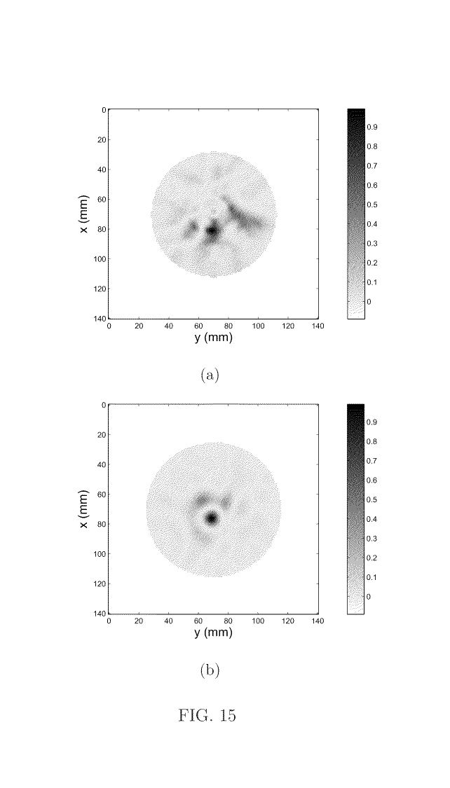

FIG. 15 shows an image of experimental cylindrical breast model containing 10-mm tumor. The cylindrical breast model has a diameter of 10-cm and a skin thickness of 2-mm. The center of the model is (70,70)-cm. The 1-cm tumor is located approximately at (80,70)-cm. FIG. 15(a) is before tumor response estimation applied, while FIG. 15(b) is after tumor response estimation applied. The experimental data presented in FIG. 15 demonstrates that the 10-mm target was easily detected and localized. Clutter was evident in the image of the phantom, and originating from skin reflections that are not perfectly cancelled, and small air pockets in the fatty tissue phantom that resulted from packing the phantom material into the skin. The localization error was 1.41 mm with and 1.0 mm without the application of the tumor response estimation process. A reduction of clutter was observed after the tumor response estimation process was applied. The SCR_{I} is 2.48 dB without the application of the program compared to 3.63 dB with the application of the program. Due to the limitations of the antenna, data were acquired at a single row with 16 different antenna positions. The tumor response classification process operates on feature vectors in 3-D space. Thus, a considerable increase in information is available to assist the process with its decision making in 3-D space instead of 2-D space. The lack of additional information resulted in a decrease in the accuracy and precision of the results. This is indicated by the observation that the location error of the clutter reduced data is larger by 0.4 mm compared to the non-clutter reduced data.

### Example of the Tumor Response Estimate Enhancement Process

This example presents an iterative signal-processing method used for GPR applications that has been adapted for clutter suppression in TSAR signals. The process iteratively identifies the clutter contributions in a TSAR signal. Successful identification of clutter allows for the segregation and removal of clutter from the TSAR data. The resulting residue data are dominated by the tumor response where it is transformed back to the time domain. The TSAR, focusing process uses the residue data from several antennas.

The performance of the tumor response enhancement process has been evaluated and results obtained with and without this process compared. The significant increase in both measures of TCR, (both peak-to-peak TCR_{pρ} and energy TCR_{E}) of the TSAR signals alter the application of the tumor response enhancement process indicates the high degree of clutter reduction achieved.

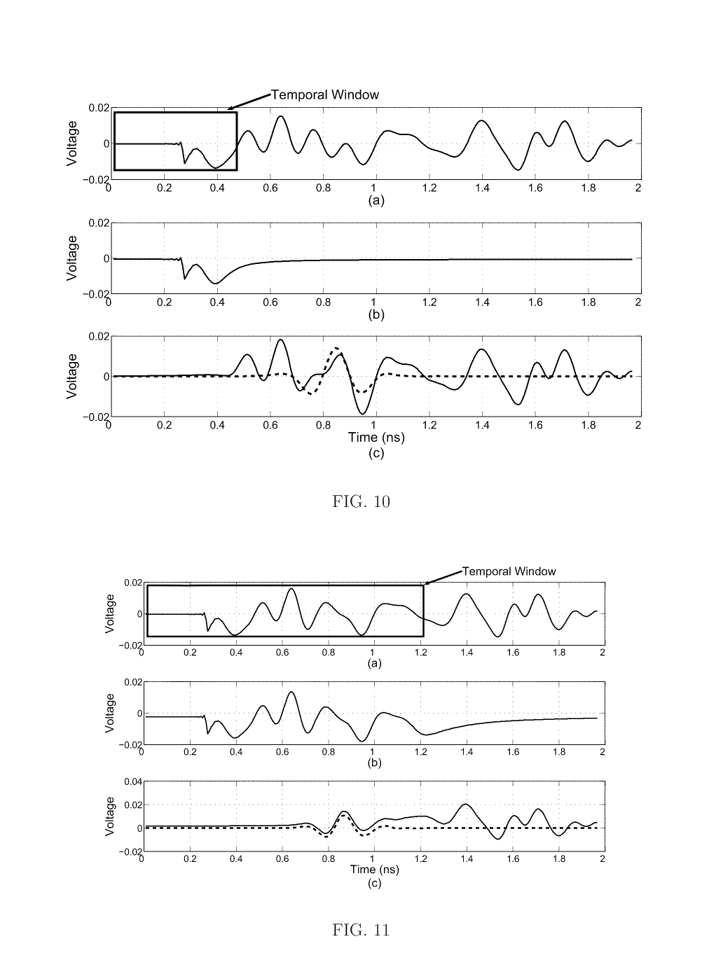

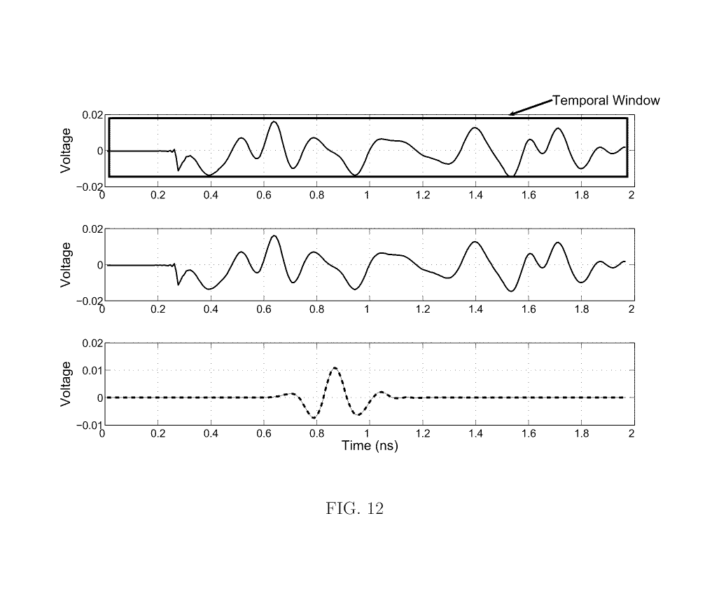

An example is provided to demonstrate the process of optional step 140. FIG. 9 demonstrates the short duration temporal window formed when the process is initialized to extract the first few high-energy, early-time clutter poles. Each frequency domain signal is transformed to the time domain for this demonstration. FIG. 9(a) shows the data Q(ω) which are formed from X(ω)−\hat{T}(ω). FIG. 9(b) shows the clutter estimate Ĉ(ω), while FIG. 9(c) shows the tumor estimate \hat{T}(ω) (broken) is superimposed onto the residue signal R(ω) (solid). FIG. 10 shows the k^{th} iteration of the tumor response estimate enhancement process. Each frequency domain signal is transformed to the time domain for this demonstration. FIG. 10(a) shows the data Q(ω) which are formed from X(ω)−\hat{T}(ω). FIG. 10(b) shows the clutter estimate Ĉ(ω), while FIG. 10(c) shows the tumor estimate \hat{T}(ω) (broken) is superimposed onto the residue signal R(ω) (solid). In later iterations, the temporal window expands, and more clutter poles are identified and extracted. This is demonstrated in FIG. 10(b), in which the clutter occurring early (in time) has been identified and removed from the signal.

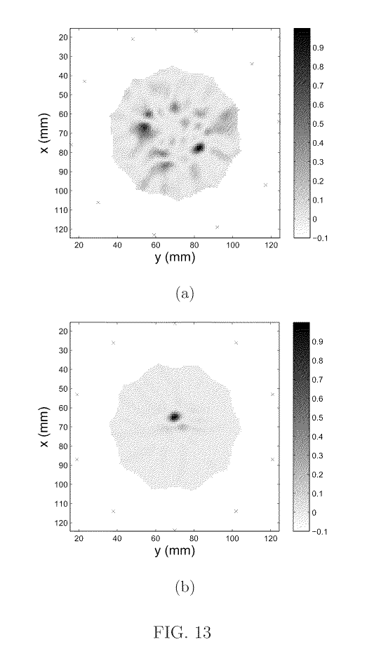

For even later iterations, the temporal window expands further to include additional clutter poles, as shown in FIG. 11(a). This improves the accuracy of the clutter estimate (FIG. 11(b)) and permits a greater amount of clutter to be removed from the signal. This higher degree of segregation is evident in FIG. 11(c), where the tumor estimate \hat{T}(ω) (broken) is superimposed onto the residue signal R(ω) (solid). The tumor estimate is now evident in the residue data.

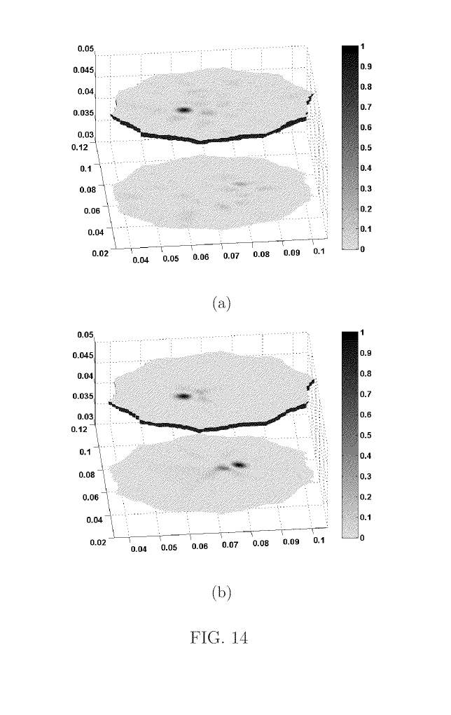

If the process is successful, then all clutter poles will be identified and separated from the other signal poles at the termination of the program. FIG. 12 shows the termination of the tumor response estimate enhancement process. Each frequency domain signal is transformed to the time domain for this demonstration. FIG. 12(a) shows the data Q(ω) which are formed by subtracting the tumor estimate \hat{T}(ω) from the TSAR signal X(ω). FIG. 12(b) shows the estimate of the clutter Ĉ(ω), while FIG. 12(c) shows the tumor estimate \hat{T}(ω) (broken) superimposed onto the residue signal R(ω) (solid). FIG. 12(c) demonstrates the high degree with which the tumor response estimate dominates the residue data.

The performance of the clutter reduction processes is investigated by applying the processes to data generated with FDTD simulations of a cylindrical model containing spherical tumors with diameters ranging from 3 to 6-mm, as described in the Methodology and Cylindrical Models used for acquiring numerical data section. A pre-processing step removes the antenna reverberations and the Woody-RLS skin-subtraction methods is used to remove the skin response. The clutter reduction processes including the feature extraction process, the classification process, the tumor response reconstruction process, and the tumor response enhancement process are sequentially applied to the pre-processed TSAR signals.

The performance of the clutter reduction process is evaluated using a single-signal analysis and the following performance measures.
1. The cross-correlation between the tumor response, t(n), and the output of the clutter reduction process, r(n). This measure evaluates the degree that the tumor response is distorted by applying the clutter reduction process to the TSAR data. It is denoted by rᵣₜ. The degree of distortion should be kept to a minimum.
2. The approximate average distance error between the tumor response, t(n), and the clutter reduction process output signal, r(n). The distance error between the tumor response and the output signal is computed from the cross-correlation lag between these two signals.
3. The peak-to-peak tumor-to-clutter ratio (TCR_{pρ} (dB)) of each TSAR signal before the application of the clutter reduction processes. This is computed using,

$$\begin{matrix}c ( n ) = x ( n ) - t ( n ) , \\ for \\ n = 0 , … , N - 1 , & ( 51 ) \\ {TCR}_{pp} = 20 {log}_{10} ( \frac{\vert {A}_{T} \vert}{\vert {A}_{C} \vert} ) & ( 52 )\end{matrix}$$

where x(n) is the pre-conditioned TSAR signal, t(n) represents the contributions from the tumor, c(n) represents the clutter contributions, and |A_{C}|, and |A_{T}| denote the magnitude of the peak-to-peak value of clutter and tumor response respectively.
4. The peak-to-peak tumor-to-clutter ratio (TCR_{pρ} (dB)) of each TSAR signal after the application of the clutter reduction processes. This is computed using,

$$\begin{matrix}{c}^{'} ( n ) = r ( n ) - t ( n ) , \\ for \\ n = 0 , … , N - 1 , & ( 53 ) \\ T {C}^{'} {R}_{pp} = 20 {log}_{10} ( \frac{\vert {A}_{T} \vert}{\vert {A}_{{C}^{'}} \vert} ) & ( 54 )\end{matrix}$$

where r(n) represents the output of the clutter reduction process, t(n) represents the contributions from the tumor, ć(n) represents the clutter contribution after the application of the clutter reduction process, and |A_{Ć}| and |A_{T}| denote the magnitude of the peak-to-peak value of the clutter after the application of the clutter reduction process, and the tumor response respectively.
5. The energy tumor-to-clutter ratio before the application of the clutter reduction processes:

$${TCR}_{E} = 10 {log}_{10} ( \frac{{E}_{t}}{{E}_{c}} ) \qquad ( 55 )$$

where E_{c} and Eₜ denote the energy of the clutter contributions and the tumor response, respectively.
6. The energy tumor-to-clutter ratio after the application of the clutter reduction processes:

$$T {C}^{'} {R}_{E} = 10 {log}_{10} ( \frac{{E}_{t}}{{E}_{{c}^{'}}} ) \qquad ( 56 )$$

where E_{ć} and Eₜ denote the energy of the clutter contributions and the tumor response, respectively.

The performance measures for tumors from 3 to 6-mm diameter are shown in Table 6. High average cross-correlation coefficient values are maintained regardless of the tumor size. This implies that the information contained in the output signal closely matches the information contained in the tumor response. That is, the process is able to detect and recover the tumor response information contained in the TSAR signals.

Secondly, the low average distance error is maintained over the range of tumor sizes tested. Collectively the results imply that the process is able to detect and recover the tumor responses in the TSAR signals with minimal distortion of the signals or loss of information, even as the tumor becomes progressively smaller. Lastly, a slight decrease in the number of signals recovered compared to the feature extraction/classification process is observed. Recall that the tumor response enhancement process is applied to the tumor response estimates evaluated by the feature extraction/classification process.

TABLE 6
Performance of the clutter reduction processes. (a) Performance
measures used to evaluate the ability of the process to recover
the tumor response. (b) Performance measures used to evaluate
the clutter suppression ability of the process.
(a) Tumor response recovery performance measures.

| Size | | Distance | Responses |
|---|---|---|---|
| (mm) | rᵣₜ | error (mm) | detected (%) |
| 3 | 0.95 | −0.166 | 48 |
| 4 | 0.96 | 0.030 | 84 |
| 5 | 0.96 | −0.104 | 90 |
| 6 | 0.97 | 0.099 | 90 |

(b) Clutter reduction performance measures.

| | | |
|---|---|---|
| Size | TCRₚₚ (dB) | TCR_{E} (dB) |

| (mm) | Before | After | Before | After |
|---|---|---|---|---|
| 6 | −4.0 | 3.80 | −5.58 | 3.71 |
| 5 | −4.52 | 5.26 | −6.32 | 4.92 |
| 4 | −7.22 | 3.59 | −9.61 | 3.54 |
| 3 | −13.1 | −2.46 | −15.65 | −2.64 |

The ability of the process to suppress clutter is demonstrated by the results in Table 6(b). Gains are observed for both the peak-to-peak tumor-to-clutter ratio and the energy tumor-to-clutter ratio for all tumor sizes. Larger gains are observed for the smaller tumor sizes. The clutter present in the signal after the application of the clutter reduction processes is primarily due to: (1) the distance error between the actual tumor response and the tumor response estimate, and (2) the inaccuracy in the scaling factor of the tumor response model.

### Example of the Application of the Process to Radar-Based Imaging Methods

### Realistic Breast Models

The process is applied to data generated from the four breast models described in the Methodology and Realistic Models used for acquiring numerical data section. The results are based on D. J. Kurrant and E. C. Fear, “An Improved Technique to Predict the Time-of-Arrival of a Tumor Response in Radar-based Breast Imaging,” IEEE Trans. Biomed. Eng. (to appear), vol. 56, April 2009, which is incorporated herein by reference in its entirety. Two versions of the process are applied to the data: (1) a version that only uses the breast surface data from a single point (discrete surface version), and (2) a version that uses the 3D breast surface estimation data and the refined tumor position estimate process (3D breast surface version). The process is applied to error-free data generated from the simple breast model in the Baseline Performance of the Process section to establish the process's baseline performance. The impact that the skin surface estimation and the presence of glandular tissues have on the performance of the process are explored using the simple glandular breast model and the bimodal breast model in the Effect of Clutter on the Predicted TOA section. Finally, the process is tested on data from the most realistic model in the Realistic Breast Model section.

Baseline Performance of the Process

The process is applied to reflections generated with the simple breast model to isolate the effect, that errors have on the predicted TOA of a tumor response. Moreover, the tissue homogeneity ensures that the tumor responses are not corrupted by clutter originating from glandular tissues. The process uses the known permittivity and also assumes perfect knowledge of the skin location at each antenna, by using the numerical model to determine the actual skin location.

FIG. 18 shows a representation of the two arrays used for tests performed in this section. Classified antennas (solid dots) are used to estimate the tumor location. Each row of antennas is separated by 10 mm in z direction, and each column is separated by approximately 3 mm in y direction. Starting with a₁, the TOA for each boundary antenna (white dot) is predicted using an antenna from the classified array. Once the antenna is classified, the tumor response is used to update the estimated tumor position. The arrays used to demonstrate Steps 2 and 3 of the classification process are shown in FIG. 18(a) and FIG. 18(b), respectively. As shown in FIG. 18(a) (and as described in the Object Response Classification—Alternate Process for Step 120, the process uses the five-element array from the initialization step (Step 1) to estimate the tumor's position. The predicted tumor response TOA for a₁ is computed using the estimated tumor position and information from the antenna closest to a₁. The estimated tumor position is then updated by including the classified tumor response from a₁, and the process is repeated for a₂. The process is continued in a similar fashion to predict the tumor response TOA for the remaining antennas (Step 2). The order in which the antennas are processed is shown in Table 7. The actual tumor responses and TOA are acquired using the procedure described in the Methodology and Realistic Models used for acquiring numerical data section. The TOA errors (TOA_{E}) are computed using (116) where the predicted TOA is computed with the discrete surface version of the process for each antenna. The TOA_{E} that occur when using the 3D breast surface version of the process are shown in the second column of Table 7. The results demonstrate that the error in the predicted TOA is very small for both versions of the process. In this case the 3D breast surface version provides superior performance over the discrete surface version. These tests also demonstrate that the process is robust during the initial stages when data are available from a very limited number of antennas.

Next, with the 3×3 array of antennas classified as described above, the antennas adjacent to the array are considered (Step 3). This scenario is shown in FIG. 18(b). The antennas are processed using the procedure described above in the order shown in Table 8. The TOA errors computed using the discrete surface version and the 3D breast surface version of the process are shown in the first and second columns of Table 8, respectively. In this case, the discrete surface version provides marginally improved performance over the 3D breast surface version. The baseline errors shown in Tables 7 and 8 that occur with the use of either version of the process correspond to less than 1 mm in tissue with relative permittivity of 9, indicating that the technique may be used to accurately predict the TOA

TABLE 7
Results when the process is applied to antennas in Step 2.

| Ant. | TOA_{E} (1) | TOA_{E} (2) | TOA_{E} (3) | TOA_{E} (4) |
|---|---|---|---|---|
| α₁ | 15.36 | 1.44 | 4.32 | 12.48 |
| α₂ | −5.28 | 3.84 | 18.24 | 19.68 |
| α₃ | 1.92 | −0.48 | 48 | 59.04 |
| α₄ | 22.56 | −8.64 | 10.08 | −8.16 |
| Avg. | 8.64 | −0.96 | 20.16 | 20.76 |

TOA errors (TOA_{E}) identified as follows: discrete surface version applied to simple breast model (TOA_{E}(1)), 3D breast surface version applied to simple breast model (TOA_{E}(2)), discrete surface data version applied to simple glandular model (TOA_{E}(3)), 3D breast surface version applied to simple glandular model (TOA_{E}(4)). Errors expressed in pico-seconds.

of a tumor response for a simple breast model.

Effect of Clutter on the Predicted TOA

In a realistic setting, the breast has variability in the tissue properties and distribution. To evaluate the performance of the process in this scenario, the process is first applied to data generated with the simple glandular model. Since the breast tissue permittivity is not known a-priori, an average background value of ε_{b}=9 is assumed. The difference between the assumed average breast tissue permittivity and the actual average permittivity is −0.98 (i.e. E{ε_{b}}=−0.98) which may lead to biased data. The permittivity data may also be perturbed due to the presence of glandular tissue.

The skin location data are estimated using the TSAR deconvolution and breast surface estimation processes. The skin location data may therefore be biased and have random perturbations. The error in the antenna-to-breast surface distance, δΔo, is computed as

δΔo=Δo_{act}−Δoₑₛₜ (57)

where Δo_{act} is the actual antenna-to-breast surface distance computed using the numerical

TABLE 8
Results when the process is applied to antennas in Step 3.

| Ant. | TOA_{E} (1) | TOA_{E} (2) | TOA_{E} (3) | TOA_{E} (4) |
|---|---|---|---|---|
| α₁ | 13.92 | 7.68 | 78.72 | −71.04 |
| α₂ | −10.08 | −8.64 | 12 | 14.88 |
| α₃ | −4.32 | 0.96 | 17.76 | 17.76 |
| α₄ | 3.36 | 20.16 | 23.52 | 35.04 |
| α₅ | 5.76 | −0.96 | 16.32 | 20.64 |
| α₆ | −3.36 | 12.96 | −2.88 | −9.6 |
| α₇ | −14.88 | −10.08 | −5.76 | −2.4 |
| α₈ | 1.44 | −2.4 | −0.48 | 0.96 |
| α₉ | 5.28 | 6.24 | −5.28 | −1.92 |
| α₁₀ | 9.12 | 37.44 | −8.16 | −10.08 |
| α₁₁ | 10.08 | −6.24 | −17.28 | −5.28 |
| α₁₂ | 0 | −12.96 | −22.56 | −23.52 |
| Avg. | 1.36 | 3.68 | 7.16 | −2.88 |

Refer to Table 7 for the TOA error descriptions. Errors expressed in pico-seconds.

model, and Δoₑₛₜ is the antenna-to-breast surface distance estimated using deconvolution data or 3D breast surface estimation data. The Δo errors computed for the antennas in Steps 2 and 3 are summarized in Tables 9 (a) and (b), respectively. The average error for Δo suggests that the 3D breast surface version of the process computes the antenna-to-breast surface distance more accurately compared to the discrete surface version. The result is expected since the 3D breast surface version considers the angle of incidence of the propagation path, whereas the discrete surface data version only determines the shortest distance from the antenna to the breast surface (regardless of the propagation path).

Finally, clutter-contaminated tumor responses and errors in skin location lead to

TABLE 9
Error in data used to compute predicted TOA for antennas in
(a) Step 2, and (b) Step 3. Error in Δo when discrete surface
data version used is identified as δΔo(1), and
δΔo(2) when 3D breast surface version used.

| | δΔo | δΔo | | | δΔo | δΔo | |
|---|---|---|---|---|---|---|---|
| | (1) | (2) | δTOA | | (1) | (2) | δTOA |
| | (mm) | (mm) | (ps) | | (mm) | (mm) | (ps) |
| Max. | −0.39 | 1.3 | 30.7 | Max. | −0.37 | 1.19 | 30.7 |
| Min. | −2.51 | −1.34 | −49.4 | Min. | −2.56 | −1.23 | −49.4 |
| Avg. | −1.4 | −0.2 | −13.6 | Avg. | −1.4 | −0.1 | −9.2 |

| | |
|---|---|
| (a) | (b) |

small variations of the estimated TOA data. The error in the TOA is computed as

δTOA=TOA_{act}−TOAₑₛₜ (58)

where TOA_{act} is the TOA of the actual tumor response acquired using a method, and TOAₑₛₜ is the TOA of the estimated tumor response. The errors in the TOA for the two scenarios (Steps 2 and 3) are summarized in Table 9 (a) and (b), demonstrating similar errors for both cases.

The predicted TOAs of the bordering antennas for the two scenarios (antennas in steps 2 and 3) are processed as described in the Baseline Performance of the Process section. The order in which the antennas are processed is shown in Tables 7 and 8. The TOA errors that occur when using the discrete surface version and the 3D breast surface version of the process for each antenna are shown in the third and forth column of each Table, respectively.

Both versions of the process provide comparable performance for the small array used in Step 2. The presence of clutter in the signals leads to an increase in the TOA error for both versions of the process when compared to the simple case. As indicated above, the 3D breast surface version of the process provides superior performance over the discrete surface version for computing Δo. Hence, the results suggest that the perturbation

TABLE 10
Results for Steps 2 and 3 of classification process shown in
(a) and (b), respectively. Skin location errors (δΔo) and
TOA errors (δTOA) in bimodal breast model data are shown
in the first two columns. Predicted TOA errors (TOA_{E})
of the target responses of the antennas are shown in the third
column of each table.

| | δΔo | δTOA | TOA_{E} | | δΔo | δTOA | TOA_{E} |
|---|---|---|---|---|---|---|---|
| | (mm) | (ps) | (ps) | | (mm) | (ps) | (ps) |
| Max. | 5.1 | 27.8 | 24.5 | Max. | 4.5 | 38.9 | 106.6 |
| Min. | 1.0 | −22.1 | −77.8 | Min. | 0 | −22.1 | −12.0 |
| Avg. | 2.2 | 7.0 | −15.4 | Avg. | 2.4 | 10.8 | 17.9 |

| | |
|---|---|
| (a) | (b) |

of the TOA data of the antenna array has a more significant influence on the performance of the process for small arrays.

Conversely, for the larger array in Step 3, improvement in the estimation of the Δo and the Δb components of the propagation path lengths leads to an overall reduction in the TOA errors. Consequently, the performance of the 3D breast surface version provides superior performance over the discrete surface version, for the larger array. As expected, compared to the 5-element array, increased information provided by the larger array leads to a significant reduction in the TOA errors for both versions of the process.

The least squares estimation method may fail when outliers are present in the data. This scenario may occur if there is an antenna that has detected a response with a TOA that is significantly different from the other antennas in the array. However, this situation is prevented from occurring when the process is applied to the data; a comparison of estimated and predicted arrival times ensures that only those antennas which have detected an object in the same area of the breast are selected to construct (30). For example, Tables 7 and 8 suggest that the predicted TOA does not deviate significantly from the TOA of the actual response (as calculated using the description provided in the Methodology and Realistic Models used for acquiring numerical data section for antennas a₄ and a₈ in Step 3. However, the clutter contributions dominate these two signals. A comparison between the predicted TOA and the feature information extracted at these two antennas does not support the inference of a tumor response. The predicted TOA of the tumor response for a₄ using (37) may be 1392.5 ps and the TOA of the response extracted by the feature extraction process may be 1427.52 ps so that the difference between the two values is 138.72 ps. The classification process may reject the response received by the antenna since this large deviation implies that the source of the response is about 7 mm from the predicted location (i.e. the response originates from a scattering mechanism associated with clutter). Likewise, the response received by as is also rejected since it originates more than 8 mm (or 165.6 ps) from the predicted source of the response. This may provide a powerful mechanism for discriminating between clutter and a tumor response.

Next, the 3D breast surface version of the may be applied to data generated with the bimodal breast model. In this case, the difference between the assumed average breast tissue permittivity and the actual average permittivity is −1.25 (i.e. E{ε_{b}}=−1.25). The skin location error (δΔo) and TOA input data error (δTOA) for Steps 2 and 3 are shown in the first two columns of Table 11 and are computed using (57) and (58), respectively. The predicted TOA of the bordering antennas may be processed. The TOA errors that occur when using the 3D breast surface version of the process for each antenna in Steps 2 and 3 are summarized in the third column of Table 10 (a) and (b), respectively. The average error after Step 3 translates to less than 1 mm in tissue with relative permittivity of 9. The results demonstrate that the process is robust as the model becomes increasingly more complex, even with only 5 elements.

Realistic Breast Model

Finally, the performance of the may be evaluated using data generated with the realistic breast model that includes dispersive tissues with properties based on measurement studies and a realistic tumor. As with the simple breast model and the bimodal breast model, an average relative permittivity is assumed for the breast tissue. The difference between the assumed (ε_{b}=9.0) and actual (ε_{b}=23.88) average relative permittivity is −14.88 at 3.6

TABLE 11
Predicted TOA errors of target response of antennas from
a 5 element array that expands to include 12 antennas.

| | TOA_{E} (ps) |
|---|---|
| Max. | 56.5 |
| Min. | −83.6 |
| Avg. | −22.3 |

### GHz.

Only the 3D breast surface version of the process is applied. Starting with a five-element array to estimate the tumor position, the process may predict the target response TOA for the adjacent antennas as described in the Baseline Performance of the Process section and the Effect of Clutter on the Predicted TOA section. The initial iteration uses skin location data acquired by a peak-detection process. After the initialization, the process uses a 3D surface map constructed from the MR scans. The results are summarized in Table 11 and are comparable to the other cases examined. This demonstrates that the process is robust to a significant variation in the breast tissue properties and a complex tumor shape. It is also noted that fewer antennas are used during the breast scan when compared to the previously examined breast models, leading to a coarser scan pattern. The tumor response is also evident at fewer antennas due to the presence of high permittivity glandular tissues. These factors collectively lead to a decrease in the information available to localize the scatter source when compared to previous cases. This motivates the need for a process capable of accurately predicting the time-of-arrival of tumor responses in a complex scenario. The results presented in Table 11 demonstrate the robustness of the TOA process.

Description of the Total Least Squares—Prony Method

Consider the case where a pre-conditioned frequency domain TSAR signal is parameterized using a summation of complex damped sinusoids given by,

$${x}_{n} = {\sum }_{k = 1}^{M} {a}_{k} {e}^{- n ( {a}_{k} + j {t}_{k} )} , \\ for \\ n = 0 , … , N - 1 \qquad ( 59 )$$

where {xₙ}ₙ₌₀^{N-1} are the signal samples, M is the number of complex sinusoids needed to model x(n), aₖ is the amplitude of the k^{th} sinusoid, αₖ is the damping factor of the k^{th} sinusoid, tₖ is the time delay of the k^{th} sinusoid.

The complex damped exponential term for each k, k=1, . . . , K is denoted by the complex pole zₖ,

zₖ=e^{-(α}^{ₖ}^{+jt}^{ₖ}⁾. (60)

Substituting (60) into (59) leads to,

$${x}_{n} = {\sum }_{k = 1}^{M} {a}_{k} {z}_{k}^{n} , \\ n = 0 , … , N - 1 \qquad ( 61 )$$

In this context, {zₖ}=ₖ₌₁^{M} are referred to as the signal modes, and {aₖ}ₖ₌₀^{M} are the associated modal strengths, and together form M pairs (aₖ, zₖ).

Equation (61) can be re-written in a more compact matrix form as,

$$\begin{matrix}x = H Θ \\ where , & ( 62 ) \\ x = [ \begin{matrix}\begin{matrix}\begin{matrix}{x}_{0} \\ {x}_{1}\end{matrix} \\ ⋮\end{matrix} \\ {x}_{N - 1}\end{matrix} ] , \\ H = [ \begin{matrix}1 & … & 1 \\ {z}_{1} & … & {z}_{M} \\ {z}_{1}^{2} & … & {z}_{M}^{2} \\ ⋮ & … & ⋮ \\ {z}_{1}^{N - 1} & … & {z}_{M}^{N - 1}\end{matrix} ] \\ Θ = [ \begin{matrix}\begin{matrix}\begin{matrix}{a}_{1} \\ {a}_{2}\end{matrix} \\ ⋮\end{matrix} \\ {a}_{M}\end{matrix} ] & ( 63 )\end{matrix}$$

The columns of H are the signal modes, and vector Θ contains the associated modal strengths. We observe that H is a Cauchy-Vandermonde matrix, and we assume that the columns are linearly independent (i.e. H has full rank). This assumption implies that there are no repeated modes (i.e. the modes are distinct). Estimating the modes and associated modal strengths in Equation (62) is a non-linear estimation problem since the signal model is non-linear in the signal modes. This section describes the separability of parameters estimation technique used to estimate the non-linear and linear parameters of (62). The method takes a two step approach: (1) The non-linear parameters (i.e. the signal modes of H) are estimated using the TLS-Prony method (2) The estimates of the modes Ĥ are substituted into (62) in order to estimate the linear parameters (i.e. the modal strengths aₖ) via ordinary least squares (OLS) solution.

First, the TLS-Prony method is described. In the Linear Difference Equation Background Section, a review of linear difference equation theory is provided. This is helpful, since the signal model given by Equation (59) is a solution to a homogeneous linear difference equation. The linear difference equation theory may be used to formulate a strategy for estimating the non-linear parameters of Equation (59). The Singular Value Decomposition (SVD) may be used in association with the TLS-Prony method. The mathematical concept is reviewed in the Singular Value Decomposition and the Frobenius Norm Section along with certain applications (namely, the Eckart-Young-Mirsky matrix Approximation Theorem). The TLS-Prony problem is formally introduced and summarized in the Total Least Square Problem Section. Finally, the OLS technique used to estimate the signal model's linear parameters is described in the Solve for Signal Model's Linear Parameters Section.

Linear Difference Equation Background

In one embodiment, estimates of the non-linear parameters for the signal model given by Equation (59) may be solved. For example, provided the signal modes are distinct, then (61) is the solution to an Mth-order set of homogeneous linear difference equations given by

$${\sum }_{k = 0}^{M} {c}_{k} {x}_{n + M - k} = 0 , \\ n = 0 , 1 , … , N - M - 1 \qquad ( 64 )$$

The relationship between the homogeneous linear difference equation given by (64) and its solution given by (61) is provided by the following three Theorems.
Theorem 1 The homogeneous linear difference equation given by (64) has solutions of the form

xₙ=zⁿ (65)

where zε [symbol] , z≠0, and satisfies

$$C ( z ) = {\sum }_{k = 0}^{M} {c}_{k} {z}^{M - k} = 0 , \\ {c}_{0} = - 1. \qquad ( 66 )$$

Equation (66) is a polynomial that has M solutions in the complex field, and is called the characteristic polynomial. Furthermore, it is said to be the characteristic equation of the homogeneous linear difference equation given by (64).
Theorem 2 If the roots z₁, z₂, . . . , z_{M} of the characteristic polynomial C(z) given by (66) are distinct, then z₁ⁿ, z₂ⁿ, . . . , z_{M}ⁿ are linearly independent solutions of the homogeneous linear difference equation (64).
Theorem 3 The space S of solutions of (64) is a vector space of dimension M.

From Theorem 3, it follows that if the roots of the characteristic polynomial C(z) are distinct, then any solution of the homogeneous linear difference equation (64) can be expressed in the form,

$${x}_{n} = {\sum }_{k = 1}^{M} {c}_{i} {z}_{k}^{n} . \qquad ( 67 )$$

We can use (67) to form the homogeneous system of N−M linear difference equations as follows,

$$\begin{matrix}{\sum }_{k = 0}^{M} {c}_{k} {x}_{n + M - k} = 0 , \\ n = 0 , 1 , … , N - M - 1 & ( 68 ) \\ {\sum }_{k = 1}^{M} {c}_{k} {x}_{n + M - k} = {x}_{M + n \text{:}} \\ n = 0 , 1 , … , N - M - 1 & ( 69 )\end{matrix}$$

In linear prediction theory, (69) is interpreted as a system of linear prediction (LP) equations, which can be written as an overdetermined set of linear equations,

$$\begin{matrix}[ \begin{matrix}{x}_{0} & {x}_{1} & … & {x}_{M - 1} \\ {x}_{1} & {x}_{2} & … & {x}_{M} \\ ⋮ & ⋮ & & ⋮ \\ {x}_{N - M - 1} & {x}_{N - M} & … & {x}_{N - 2}\end{matrix} ] [ \begin{matrix}\begin{matrix}\begin{matrix}{c}_{M} \\ {c}_{M - 1}\end{matrix} \\ ⋮\end{matrix} \\ {c}_{1}\end{matrix} ] \approx [ \begin{matrix}\begin{matrix}\begin{matrix}{x}_{M} \\ {x}_{M + 1}\end{matrix} \\ ⋮\end{matrix} \\ {x}_{N - 1}\end{matrix} ] \text{:} \\ or & ( 70 ) \\ Ac \approx b & ( 71 )\end{matrix}$$

where A is the LP data matrix using the data in the forward direction, c is the LP vector, and b is the observation vector.

Hence, Theorems 1-3 may be used to formulate a strategy for estimating the non-linear parameters given in Equation (61). This strategy may be summarized as follows,
1. Form a system of N−M LP equations using (69), which can be expressed in matrix form as Ac≈b.
2. Solve for the LP vector c, which corresponds to the M coefficients of the linear prediction error filter polynomial C(z)=1−c₁z⁻¹−c₂z⁻²− . . . −c_{M}z^{-M}.
3. With the coefficients of the prediction error filter polynomial known, invoke Theorem 1 and then use a root finding technique to find the M roots of the associated characteristic equation.
4. Invoke Theorems 2-3, which allow us to use the M roots of the characteristic equation to form the M columns of the Vandermonde matrix, H.
   In step 2 of this method, a certain technique may solve for the LP vector c. For example, in the classical OLS approach, the measurements (that form the LP data matrix A) of the variables cₖ are assumed to be error free. Hence, all errors are confined to the observation vector b. However, the assumption may not be realistic in this case, since A is the LP data matrix which contains measured data corrupted by errors. The method of TLS is an estimation technique which has been devised to compensate for the data error in both the observation vector b and the LP data matrix A. The TLS method makes use of a number of tools in order to estimate a solution. A review of these tools is provided next.

Singular Value Decomposition and the Frobenius Norm

The Singular Value Decomposition (SVD) is an important and practical theoretical tool that is used by the TLS method. It is also used by the Subspace Decomposition technique described in the Estimating the Number of Signal Modes in a Waveform using a Subspace Decomposition Technique section for finding the number of modes contained in a TSAR signal.

Theorem 4 If Bε [symbol] then there exist orthonormal matrices U=[u₁, . . . , uₘ]ε [symbol] and V=[v₁, . . . , vₙ]ε [symbol] such that

U^{H}BV=Σ=diag(σ₁, . . . , σₚ), σ₁≧ . . . ≧σₚ≧0 (72)

The σᵢ are the singular values of B and their set is called the singular value spectrum. The vectors vᵢ and uᵢ are the i^{th} left singular vector and the i^{th} right singular vector, respectively.

The SVD may reveal a great deal about the structure of a matrix. If the SVD of B is given by Theorem 4, then it may be convenient, to separate the matrices in the SVD into two parts, corresponding to the zero singular values and the non-zero singular values. Define r by,

σ₁≧ . . . ≧σᵣ≧σᵣ₊₁= . . . =σₚ=0 (73)

then,

rank(B)=r (Rank of B). (74)

N(B)=span(vᵣ₊₁, . . . , vₙ) (Null space of B). (75)

Furthermore, the SVD expansion may be given by

$$B = U Σ {V}^{H} = {\sum }_{i = 1}^{T} {σ}_{i} {u}_{i} {v}_{i}^{H} \qquad ( 76 )$$

Equation (76), also called the dyadic decomposition, decomposes the matrix B of rank r in a sum of r matrices of rank one.

The SVD may also be used to characterize the Frobenius norm and the l₂ norm,

$$\begin{matrix}{‖ C ‖}_{F}^{2} = {\sum }_{i = 1}^{m} {\sum }_{j = 1}^{n} {c}_{ij}^{2} = {σ}_{1} + … + {σ}_{p} & ( 77 ) \\ {‖ C ‖}_{2} = {sup}_{y \neq 0} \frac{{‖ Cy ‖}_{2}}{{‖ y ‖}_{2}} = {σ}_{1} . & ( 78 )\end{matrix}$$

Filially, the SVD may be used be used to approximate one matrix with another with lower rank. This is provided by Theorem 5.
Theorem 5 (Eckart-Young-Mirsky Matrix Approximation Theorem) Let the SVD of Bε [symbol] be given by B=Σᵢ₌₌₁^{r}σᵢuᵢvᵢ^{H}, where r=rank(B). If k<r and Bₖ=Σᵢ₌₁^{k}σᵢuᵢvᵢ^{H}, then

∥B−Bₖ∥₂=σₖ₊₁, (79)

and Bₖ is the nearest matrix of rank k to B (in the l₂-norm):

$$\begin{matrix}{min}_{rank ( D ) = k} {‖ B - D ‖}_{2} \\ Likewise , & ( 80 ) \\ {‖ B - {B}_{k} ‖}_{F} = \sqrt{{\sum }_{i = k + 1}^{p} {σ}_{i}^{2}} , & ( 81 )\end{matrix}$$

and, Bₖ is the nearest matrix of rank, k to B (in the Frobenius-norm):

$${min}_{rank ( D ) = k} {‖ B - D ‖}_{F} = {‖ B - {B}_{k} ‖}_{F} ; \\ p = min \{ m , n \} \qquad ( 82 )$$

Theorem 5 demonstrates how the SVD of a matrix can be used to determine how near (in either the l₂-norm or the Frobenius-norm) the matrix is to a matrix of lower rank. Furthermore, the SVD can also be used to find the nearest matrix of a given lower rank. That is, a matrix having singular values σₖ₊₁, . . . , σᵣ that are much smaller than the singular values σ₁, . . . , oₖ is by Theorem 5, close to a matrix having only k non-zero singular values. Even though the rank of the matrix might be greater than k, since the matrix is close to a matrix of rank k, its effective rank is only k.

Total Least Square Problem

Recall that the signal model given by Equation (61) is the solution for a system of LP equations given by Equation (69). The system of LP equations may be used to form an LP data matrix given by Equation (71). For example, the SVD may be used to find a lower rank approximation of the LP data matrix A in Equation (71) in order to mitigate the effect of noise in A. Moreover, they may suggest using a prediction order which is much higher than the number of modes M present in the signal. In another embodiment increasing the filter length to L such that M≦L≦N−M may decrease the sensitivity of the estimated parameters to noise and reduce the numerical ill conditioning. In particular, the extraneous zeros introduced may protect the signal zeros against the noise-perturbation effect. Consequently, the system of LP equations may be modified to incorporate the higher prediction order:

$${\sum }_{k = 1}^{L} {c}_{k} {x}_{n + L - k} = {x}_{L + n} , n = 0 , 1 , … , N - L - 1. \qquad ( 83 )$$

The system of equations can be written as an overdetermined set of N−L LP equations,

$$\begin{matrix}[ \begin{matrix}{x}_{0} & {x}_{1} & … & {x}_{L - 1} \\ {x}_{1} & {x}_{2} & … & {x}_{L} \\ ⋮ & ⋮ & & ⋮ \\ {x}_{N - L - 1} & {x}_{N - L} & … & {x}_{N - 2}\end{matrix} ] [ \begin{matrix}{c}_{L} \\ {c}_{L - 1} \\ ⋮ \\ {c}_{1}\end{matrix} ] \approx [ \begin{matrix}{x}_{L} \\ {x}_{L - 1} \\ ⋮ \\ {x}_{N - 1}\end{matrix} ] , & ( 84 ) \\ Ac \approx b & ( 85 )\end{matrix}$$

where A is the LP data matrix using the data in the forward direction, c is the LP vector, b is the observation vector, and L is the prediction order satisfying M≦L≦N−M.

Both the LP data matrix A and the observation vector b may be assumed to be in error. That is, the idea behind the TLS method is to consider perturbations of both b and A so that,

(A+ΔA)c=b+Δb (86)

which can be re-arranged to form the homogeneous equation,

$$\begin{matrix}( [ A ; b ] + [ Δ A ; Δ b ] ) [ \frac{c}{- 1} ] = 0 & ( 87 ) \\ ( B + Δ ) α = 0 \\ where & ( 88 ) \\ B = [ A ; b ] , \\ Δ = [ Δ A ; Δ b ] , \\ α = [ \frac{c}{- 1} ] . & ( 89 )\end{matrix}$$

The TLS solution to the homogeneous equation given by (88) can be formulated as seeking a solution vector c such that,

(b+Δb)εrange(A+ΔA), (90)

and the norm of the perturbations may be minimized.

In order for the homogeneous equation given by Equation (88) to have a solution, the augmented vector [c^{T}, −1]^{T} may lie in the null space of (B+ΔB). In order for the solution to be trivial, the perturbation ΔB may be such that B+ΔB is rank deficient. The SVD and Theorem 5 are used to find the TLS solution.

The SVD of the augmented LP data matrix B results in Equations (72) and (76). If the measurements are noiseless and the data fits the model, then the model is given by (67). Therefore, B has a rank M and only the first M singular values in (72) are non-zero, and the remaining singular values are zero. That is,

σ_{M+1}=σ_{M+2}= . . . =σ_{L+1}=0. (91)

In practice, this is not the case since the LP data matrix B is contaminated by noise. This means that B is full ranked. Theorem 5 tells us that although B is full ranked, it will be ‘close’ to a matrix B′ of lower rank M. Hence, we have

σ_{M+1}≈σ_{M+2}≈ . . . ≈σ_{L+1}≈0. (92)

However, the correct number of signal modes, M, may not be known a priori, and may be estimated. The subspace decomposition technique that is used to achieve this estimation is described in the Estimating the Number of Signal Modes in a Waveform using a Subspace Decomposition Technique section.

Define the column partition of the unitary matrix V derived from the SVD of B as,

\tilde{V}=[v_{M+1},v_{M+2}, . . . , v_{L+1}], (93)

and construct, the subspace S_{c} from the column vectors of \tilde{V}.

S_{c}=range(\tilde{V})=span(v_{M+1},v_{M+2}, . . . , v_{L+1}), (94)

which is, by Equation (75), the null space of B. This means that the solution αεS_{c}. The solution is not unique, so we can derive any vector from the null space S_{c}. However, it is possible to single out a unique solution in the sense of a minimum norm. In one embodiment, the solution to the minimum norm TLS problem may be solved using \tilde{V} and computing an orthonormal Householder matrix Q such that,

$$\tilde{V} Q = [ \begin{matrix} & Y & & y \\ 0 & … & 0 & γ\end{matrix} ] \qquad ( 95 )$$

If γ≠0, then the TLS solution is,

$$\hat{c} = \frac{- y}{γ} . \qquad ( 96 )$$

The TLS approximation and corresponding TLS correction matrix are given by,

$$\begin{matrix}[ \hat{A} ; \hat{b} ] = [ A - Δ \hat{A} ; b - Δ \hat{b} ] with [ Δ \hat{A} ; Δ \hat{b} ] \\ = [ A ; b ] [ \begin{matrix}y \\ γ\end{matrix} ] [ {y}^{T} ; γ ]\end{matrix} \qquad ( 97 )$$

By the properties of the Householder matrix, the vector [y^{T}, γ]^{T} is the vector in the ranged (\tilde{V}) such that the last column of \tilde{V}Q is maximized, subject to the constraint that the last column of Q is normalized to a unit vector (i.e. ∥q_{L-M}∥₂=1). Thus ĉ=−y/α is the minimum-norm TLS solution.

The TLS computations used to solve TLS problem in which a non-unique solution does not exist (due to the presence of the singularities that are approximately repetitive) may be summarized as follows. In the case of non-uniqueness, the minimum norm TLS solution is computed.

Given an N−L×L+1 data matrix B and an L+1×1 observation vector b.
1. Use Theorem 4 to compute the SVD of the augmented LP data matrix. B=[A; b]=UΣV^{H}.
2. Determine the Numerical Rank of B.
   Use the rank determinator from the Estimating the Number of Signal Modes in a Waveform using a Subspace Decomposition Technique section. The rank determinator tells us,

σ₁²≧σ₂² . . . ≧σ_{M-1}²>r(M)≧σ_{M+1}²≧σ_{L+1}², (98)
where r(M) is the value the rank determinator which is used to estimate the number of signal modes M.
3. Compute the TLS solution.
   (a) Use the estimate \hat{M} and the unitary matrix V to construct \tilde{V}.
   (b) Compute a Householder matrix Q such that the last column is normalized to a unit vector.
   (c) Use Equation (96) to compute [y^{T}, γ]^{T}. If, γ≠0, then the TLS solution is given by

$$\hat{c} = \frac{- y}{γ} .$$

Solve for Signal Model's Linear Parameters

The TLS solution c represents the coefficients of the prediction-error filter polynomial (i.e. characteristic equation) given by Equation (83). The L distinct zeros, {\hat{z}ᵢ} are obtained by polynomial root finding techniques. By Theorem 2, the linearly independent solutions of (64) are z₁ⁿ, z₂ⁿ, . . . , z_{L}ⁿ. Hence, invoking Theorem 3 allows us to construct the Cauchy-Vandermonde matrix where the columns of the matrix are the signal modes.

$$\hat{H} = [ \begin{matrix}{z}_{1}^{0} & … & {z}_{L}^{0} \\ ⋮ & & ⋮ \\ {z}_{1}^{N - 1} & … & {z}_{L}^{N - 1}\end{matrix} ] . \qquad ( 99 )$$

Knowing the estimates of the signal modes, Equation (62) may be used to find the modal strengths. In particular, the modal strengths are found as the least squares solution given by,

\hat{Θ}=(Ĥ^{H}Ĥ)⁻¹Ĥ^{H}x. (100)

Of the L modes used to form H, there are M signal modes, and L−M extraneous modes associated with noise. An energy criterion is used to ensure that only the M modes with the highest energies are kept.

Estimating the Number of Signal Modes in a Waveform Using a Subspace Decomposition Technique

Consider the case where a pre-conditioned frequency domain TSAR signal is parameterized using a summation of complex damped sinusoids given by,

$${x}_{n} = {\sum }_{k = 1}^{M} {a}_{k} {e}^{- n ( {α}_{k} + j {t}_{k} )} ; for n = 0 , … , N - 1 \qquad ( 101 )$$

where {xₙ}ₙ₌₀^{N-1} are the signal samples, M is the number of complex sinusoids needed to model x(n), aₖ is the amplitude of the k^{th} sinusoid, αₖ is the damping factor of the k^{th} sinusoid, tₖ is the time delay of the k^{th} sinusoid.

The complex damped exponential term for each k, k=1, . . . , K is denoted by the complex pole zₖ,

zₖ=e^{-(α}^{ₖ}^{+jt}^{ₖ}⁾. (102)

Substituting (102) into (101) leads to,

$${x}_{n} = {\sum }_{k = 1}^{M} {a}_{k} {z}_{k}^{n} , n = 0 , … , N - 1 \qquad ( 103 )$$

In this context, {zₖ}k₌₁^{M} are referred to as the signal modes, and {aₖ}ₖ₌₀^{M} may be the associated modal strengths, and together form M pairs (aₖ, zₖ).

The number of signal modes, M, may be unknown and require estimation. The Description of the Total Least Squares—Prony Method section describes how a linear predictor (LP) equation of order L, where M≦L<N−M, is used to construct an overdetermined set of L−M linear equations, and is written compactly in matrix form as,

Ac≈b, (104)

where A is the LP data matrix using the data in the forward direction, c is the LP vector, and b is the observation vector.

The TLS-Prony method described in the Description of the Total Least Squares—Prony Method section that is used to estimate values for the linear prediction coefficients, constructs an augmented LP data matrix using (104),

B=[A;b], (105)

where Bε [symbol] A Singular Value Decomposition (SVD) of B leads to,

B=UΣV^{H}. (106)

The SVD of B is related to an estimate of the correlation matrix of B as follows,

$$\begin{matrix}\hat{R} = {B}^{H} B & ( 107 ) \\ = V {Σ}^{T} {U}^{H} U {ΣV}^{H} & ( 108 ) \\ = V {Σ}^{T} Σ {V}^{H} ( {U}^{H} U = I since U is unitary ) & ( 109 ) \\ = V Λ {V}^{H} ; & ( 110 )\end{matrix}$$

where we have ignored the scaling factor 1/(N−L). Here A is a diagonal matrix made up of the L+1 eigenvalues of the estimated correlation matrix, which means that the k-th singular value of B, σₖ, is the square root of the k-th eigenvalue, λₖ, of \hat{R} (or equivalently λₖ=σₖ²). Furthermore, the columns of V are the eigenvectors of \hat{R}.

Equation (110) can be interpreted as the eigendecomposition of \hat{R}. Ideally \hat{R}=R, so that the M largest eigenvalues are associated with the M signal modes, and the remaining eigenvalues have equal value and are associated with the noise. That is,

σ₁≧σ₂≧ . . . ≧σ_{M}>σ_{M+1}= . . . =σ_{L+1}=0 (111)

Hence, this interpretation allows partitioning of the correlation matrix into two separate subspaces: (1) a signal subspace, S, spanned by the M signal eigenvectors, and (2) a noise subspace, W, spanned by the L+1−M noise eigenvectors. Unfortunately, due to the finite number of samples used to compute \hat{R}, \hat{R}≠R, which means that the noise eigenvalues are no longer all equal to 0. This leads to difficulties when distinguishing between the signal and noise subspaces.

The aim of the subspace decomposition technique is to approximate the dimension of the subspace spanned by the columns of an estimate of the signal eigenvectors, denoted by Ŝ. An accurate estimate of the dimension implies the approximate number of signal modes contained in the waveform, x(n). The goal is achieved by ensuring that the estimated subspace Ŝ is ‘close’ to the actual signal subspace S. A measure of how close the two subspaces are from one another is implied by examining how sensitive the estimated signal subspace Ŝ is to a small perturbation. In particular, the smallest size the perturbation may have is defined by the lower bound

∥ΔS∥²≧σ_{M}, (112)

where ΔS is a perturbation matrix such that,

Ŝ=S+ΔS. (113)

This measure leads to the following observations:
1. If the estimated signal subspace is insensitive to the perturbation, then this implies that Ŝ is close to S.
2. If the estimated signal subspace is sensitive to the perturbation, then this implies that Ŝ is far away from S.
   Based on these observations, it has been shown that the sensitivity of the estimated signal subspace Ŝ to a perturbation satisfying Equation 113, is dictated by the separation between the smallest eigenvalue σ_{M-1} of the estimate of the signal subspace Ŝ, and the largest eigenvalue σ_{M} of the estimated noise subspace Ŵ. Specifically, this is determined using the following rank detection function (or rank determinator),

$$r ( M ) = \{ \begin{matrix}\frac{{σ}_{M}^{2}}{{σ}_{M - 1}^{2} - 2 {σ}_{M}^{2}} , & if {σ}_{M} \leq \frac{{σ}_{M - 1}^{2}}{3} ; \\ 1 & otherwise .\end{matrix} \qquad ( 114 )$$

which is interpreted as being an upper bound on the distance between two subspaces, and is used to estimate the rank M of the actual signal subspace S. The rank determinator is applied to all L+1 eigenvalues of \hat{R}. The order estimate \hat{M} which minimizes r(M) is,

$$\hat{M} = arg [ {min}_{M} r ( M ) , for M = 1 , … , L + 1 ] \qquad ( 115 )$$

The rank determinator value r(M)<< 1 implies that there is a gap between σ_{M-1} and σ_{M}. This, in turn, implies that Ŝ is insensitive to a perturbation of size σ_{M}². This means that Ŝ is close to S, and the decomposition into signal and noise spaces Ŝ and Ŵ are stable and well-conditioned. Conversely, a rank determinator value of r(M)≈1 implies that a well defined separation between the signal and noise does not exist, leading to a decomposition into signal and noise subspaces that is unstable and ill-conditioned. In other words, Ŝ and S are unlikely to be close to each other.

Methodology and Cylindrical Models Used for Acquiring Numerical Data

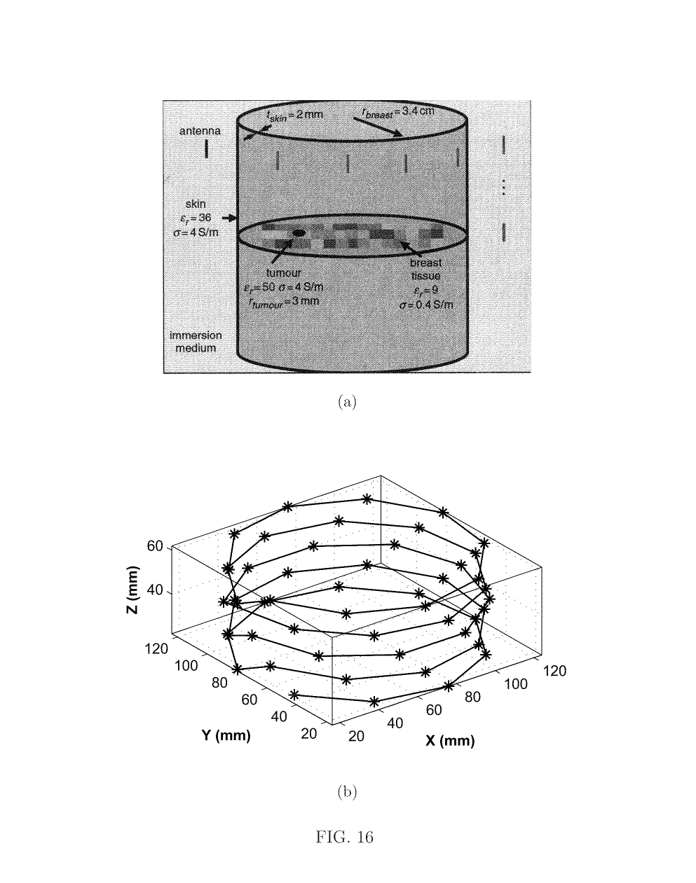

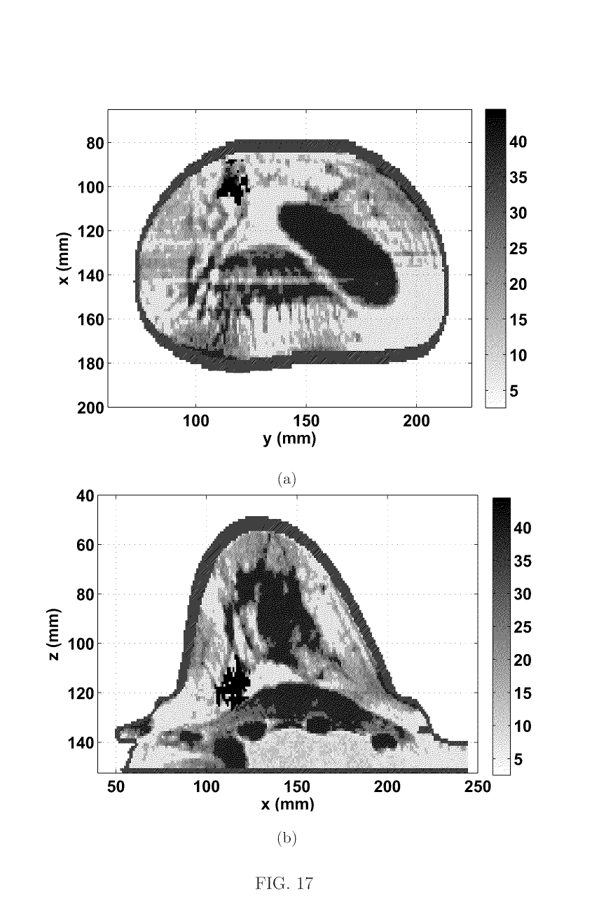

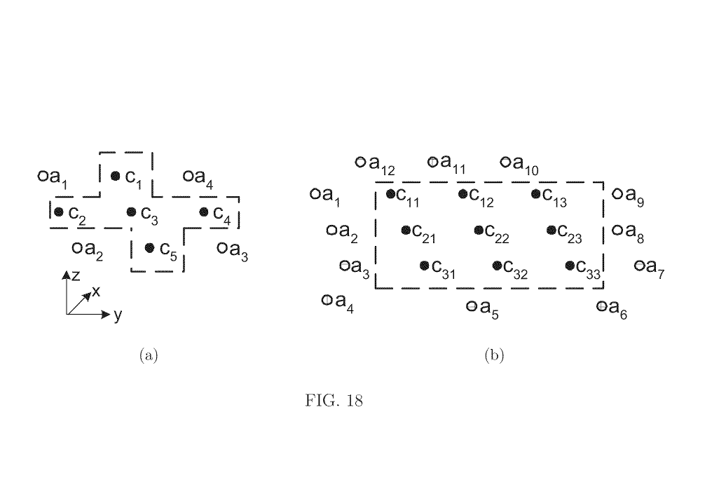

The backscatter simulation data for this study are computed using the finite-difference time-domain (FDTD) method and a simple cylindrical breast model. A simple breast model is used for generating the simulated data, for this study in order to evaluate the feasibility clutter of the reduction approach proposed. The model is a 6.8-cm-diameter cylinder surrounded by a 2-mm uniformly thick layer of skin, as shown in FIG. 16(a). Perfectly matched absorbing boundary conditions (PMLs) (parabolic profile, eight layers, 80 dB attenuation) are used for the absorbing boundary to terminate the computational domain. Hence, the cylindrical model is represented with infinite length along its axis.

The relative permittivity contrast between malignant and normal breast tissue is approximately 5:1, and the conductively contrast between the malignant and normal breast tissue is approximately 10:1. To simulate clutter, 4-mm cubes with random variations in the electrical properties of up to +/−10% are used. The 10% variation in permittivity and conductivity of the breast tissue is used in order to model the expected range in presence of both fat and fibroglandular tissue. The electrical properties of the breast model and the immersion liquid are constant over the frequency band used for the simulations. That is, material dispersion is not incorporated into the model. Tumors with varying sizes are placed in the heterogeneous breast tissue.

A single Wu-King dipole antenna is modeled. It is positioned 2 cm from the surface

TABLE 12
Electrical properties of the tissues used in the model.

| | | Conductivity |
|---|---|---|
| Material | Permittivity εᵣ | σ (S/m) |
| Skin | 36 | 4 |
| Tumor | 50 | 4 |
| Breast | 8.1-9.9 | 0.36-0.44 |
| Immersion Liquid | 3 | 0 |

It is assumed that these values are constant over the microwave frequency band used for the simulations (i.e. the model is non-dispersive.)

of the model, and is parallel to the cylindrical axis. The Wu-King resistive loading profile is designed to operate in oil at 4 GHz to provide the necessary ultra-wide band performance, fidelity, and low end reflections. Unfortunately, the performance is achieved at the cost of poor efficiency and directivity. The breast model and the antenna are both placed in an immersion liquid in order to reduce the electrical property contrast between the interior and exterior of the breast.

With the breast model present, FDTD is used to simulate the operation of the antenna. The simulations collectively represent an antenna scanned around the model. Graded mesh are used to increase the resolution close to the antenna (0.25 mm) and in regions of the breast model near the antenna. Dielectric averaging is used at the boundaries of all interfaces (i.e. boundary between two materials with different electrical properties).

The antenna is moved in a circular path around the breast to 10 different positions, forming a row. As shown in FIG. 16(b), five different rows (for a total of 50 antenna, positions) form a synthetic antenna array centered around the tumor location. At each position, the antenna is excited with an ultra-wideband Gaussian pulse that has a significant energy content between 1.4 and 8.7 GHz, and center frequency near 4 GHz. The same antenna is used to receive the reflections. The TSAR signals are acquired by the antenna at normal incidence angles. The set of signals recorded by the synthetic 50-element antenna array is defined as a scan. Three separate scans may be acquired.
1. The preliminary breast profile scan may include scanning the antenna around the perimeter of the imaging region for the purpose of acquiring information about the skin location and thickness. An additional simulation may be performed in which the antenna illuminates a metal sheet, which approximates a perfect electric conductor (PEC). The sheet is placed 1.5 cm from the antenna. A TSAR deconvolution technique may be applied to the resulting reflections in order to obtain an estimate of the impulse response of the system. Estimates of the skin thickness and surface location are extracted using the impulse response.
2. The antenna may be positioned approximately 2-cm from the surface of the skin, and a second scan may be acquired. The purpose of the second scan, known as the tumor detection scan, is to acquire scattered field information from the interior of the breast to allow the detection and localization of strongly scattering objects.
3. The recorded signals from the tumor detection scan have early and late time content. The early-time content may be dominated by the incident pulse, reflections from the skin, and antenna reverberations. Since the antennas are placed approximately 2-cm from the breast surface, the incident pulse and the skin reflection are separated in time. A calibration step is used to remove the incident pulse and antenna reverberations. It consists of recording signals from each antenna without the breast model present. Therefore, this scan is referred to as the antenna only scan. Subtracting the returns recorded at each antenna location without the breast model present reduces the incident pulse and antenna reverberations. The resulting signal is referred to as the calibration signal.

A Woody-RLS skin subtraction process is used to estimate the skin response. This is then subtracted from the signal, so that the resulting signal is referred to as the skin subtracted signal. The clutter reduction process studied for this project is applied to the pre-conditioned TSAR signal which has the antenna reverberations and estimate of the skin response removed. A typical skin subtracted signal is shown in FIG. 3(a). The signal shown is normalized to the antenna only signal.

Methodology and Realistic Models Used for Acquiring Numerical Data

To test the process, data are generated with 3D realistic breast models. The interior of the first model may be identified and filled with non-dispersive homogeneous fatty tissue having εᵣ=9, σ=0.4 S/m. A 2-mm layer of skin with εᵣ=36, σ=4 S/m is placed around the model. A 6-mm diameter spherical tumor with εᵣ=50, σ=4 S/m, is added. We call this the simple, breast, model.

The interior of the second model is the same as the first except that glandular tissue may be included by using a simple threshold technique that assigns εᵣ=16, σ=1 S/m to those pixel intensities of the MR image that exceed a pre-selected threshold. We call this the simple glandular model.

The third model is constructed by setting the fatty tissue at a constant value of εᵣ=9, σ=0.4 S/m. The glandular tissue is selected by setting a threshold range and properties may be mapped using a linear function to the histogram of the MR pixel intensities. The electromagnetic properties of the tissue range from εᵣε[15.2, 27.5] and a σε[1.7, 3.0] S/m. A 2-mm thick skin layer and a 6-mm spherical tumor are then added to form what we call the bimodal breast model.

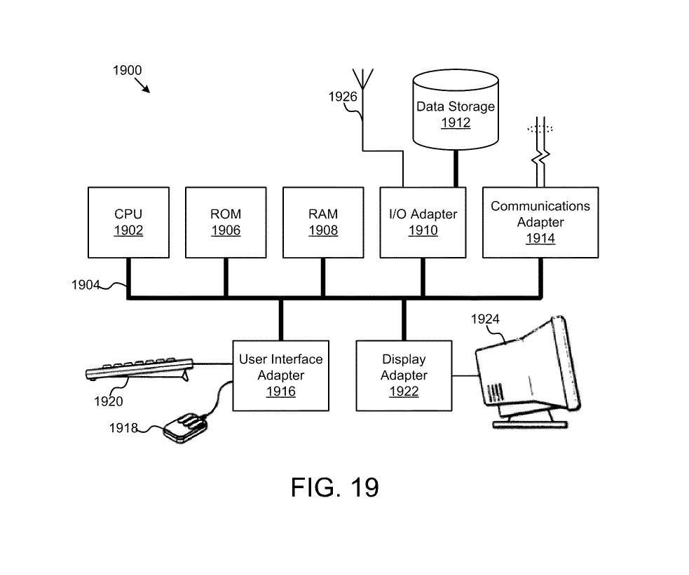

The fourth model includes dispersive tissues with properties based on recent measurement studies and a realistic tumor. The model may be generated from MR scans of a patient diagnosed with cancer. The breast model may be created with a segmentation and image processing tool (e.g. ISeg, SPEAG, Zurich, Switzerland), and is based on images collected prior to injection of a contrast agent used routinely in MR, breast imaging. First, a consistent skin layer is added to the breast model. Next, the breast interior is segmented into 19 tissues using a k-means filter. The pixel intensities are then mapped to electrical properties by first assigning ranges of pixel intensities to each of three sample tissue groups defined. These groups summarize properties of 0-30% adipose, 31-84% adipose, and 85-100% adipose tissues. Within each group, pixel intensities may be linearly mapped to the 25-75% range of values. The tumor may be extracted from images acquired after a contrast agent is administered to the patient, and inserted into the numerical breast model at the appropriate location. Although the tumor may be several centimetres in dimension, it may not be detected clinically with mammography. Coronal and sagittal cross sections of the breast model are shown in FIG. 17. These cross-sections demonstrate that the tumor is embedded in glandular tissues and located near the skin and chest wall. We term this model the realistic breast model.

To illuminate the breast models with an ultra-wideband pulse, simulations may be performed with the finite difference time domain method. One antenna may be present in each simulation and excited with a differentiated Gaussian waveform having a center frequency of 4.0 GHz and a full width half maximum bandwidth of 1.3-7.6 GHz. The antenna may be scanned to a set of locations around the breast, and simulations are performed at each location. Therefore, the coordinates of all antennas in the synthetic array are known. Breast models 1-3 may be illuminated with a resistively loaded Wu-King dipole. A synthetic antenna array may be constructed by recording reflections as the antenna is moved to 245 different positions around the breast. This represents a complete scan of the breast; typically 32 antenna positions are simulated for each row encircling the breast and rows are separated by 1 cm. A balanced antipodal Vivaldi antenna (BAVA) may be used to illuminate breast model 4. A synthetic antenna array may be constructed by recording reflections as the BAVA antenna may be moved to 128 different positions around the breast. The antenna may be scanned to 16 antenna locations per row with rows separated by 1 cm, corresponding to a partial scan of the breast.

For each antenna location, a simulation may also be performed without a tumor present. The actual tumor responses may be calculated by subtracting the tumor-free reflection from each reflection computed with the tumor present. The actual tumor response may be used to evaluate the performance of the process by allowing us to compute the deviation between the actual tumor response TOA (TOA_{actual}) and the predicted TOA for the i^{th} antenna (TOAᵢ) given by

TOA_{E}=TOA_{actual}−TOAᵢ. (116)

The signal received by each antenna may be processed using the TSAR processes. First, the location and thickness of the skin (relative to the antenna) may be estimated. For breast models 1-3, the signals may be pre-conditioned to remove the antenna reverberations and an estimate of the skin response. The set of signals may then be processed with the feature extraction process to estimate candidate tumor responses. For breast model 4, tumor responses may be extracted as described above.

FIG. 19 illustrates a computer system 1900 adapted according to certain embodiments of the present methods and processes. The central processing unit (CPU) 1902 is coupled to the system bus 1904. The CPU 1902 may be a general purpose CPU or microprocessor. The present embodiments are not restricted by the architecture of the CPU 1902 as long as the CPU 1902 supports the modules and operations as described herein. The CPU 1902 may execute the various logical instructions according to the present embodiments. For example, the CPU 1902 may execute machine-level instructions according to the exemplary operations described above with reference to FIG. 1.

The computer system 1900 also may include Random Access Memory (RAM) 1908, which may be SRAM, DRAM, SDRAM, or the like. The computer system 1900 may utilize RAM 1908 to store the various data structures used by a software application configured to identify an object within a complex environment. The computer system 1900 may also include Read Only Memory (ROM) 1906 which may be PROM, EPROM, EEPROM, or the like. The ROM may store configuration information for booting the computer system 1900. The RAM 1908 and the ROM 1906 hold user and system data.

The computer system 1900 may also include an input/output (I/O) adapter 1910, a communications adapter 1914, a user interface adapter 1916, and a display adapter 1922. The I/O adapter 1910 and/or user the interface adapter 1916 may, in certain embodiments, enable a user to interact with the computer system 1900 in order to input application settings. In a further embodiment, the display adapter 1922 may display a graphical user interface associated with a software application or display an image of the object.

The I/O adapter 1910 may connect to one or more storage devices 1912, such as one or more of a hard drive, a Compact Disk (CD) drive, a floppy disk drive, a tape drive, to the computer system 1900. In a further embodiment, the I/O adapter 1910 may connect to one or more antennas 1926. Further embodiments of an antenna 1926 are described above with relation to FIG. 6. The communications adapter 1914 may be adapted to couple the computer system 1900 to a network, which may include a LAN and/or WAN, and/or the Internet. The user interface adapter 1916 couples user input devices, such as a keyboard 1920 and a pointing device 1918, to the computer system 1900. The display adapter 1922 may be driven by the CPU 1902 to control the image display on the display device 1924.

The present embodiments are not limited to the architecture of system 1900. Rather the computer system 1900 is provided as an example of one type of computing device that may be adapted to perform the functions of computing systems. For example, any suitable processor-based device may be utilized including without limitation, including personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

A number of embodiments have been described. Nevertheless, it will be understood that various modifications may be made without departing from the spirit and scope of the concepts presented herein. For example, the processes and variations thereof can be used in any imaging or object-locating method where signals are reflected from an object in imaging or locating an object. Non-limiting examples of such methods include ground penetrating radar and seismic processing. The processes presented herein and variations thereof are applicable in fields such as medical imaging and acoustics, as examples. In other aspects, the concepts provided herein may be beneficial in locating buried land-mines (e.g. detecting the location and characteristics of hidden ordinance), finding underground electrical and natural gas utilities, identifying the location of mineral deposits, detecting explosives in luggage (i.e. security), and identifying buried corpses. Accordingly, other embodiments are within the scope of the claims.

What is claimed is:

1. A method comprising:
extracting a feature of an object response from a signal reflected by an object embedded within a complex environment;
estimating a location of the object within the environment from the object response;
comparing the feature of the object response with a feature associated with an object response of interest;
classifying the object in response to a physical location of the object and the comparison of the feature of the object with the feature of the object of interest;
reconstructing an object estimation in response to the classification; and
generating an image of the object in response to a determination that the object is classified as an object of interest.

2. The method of claim 1, wherein the extracting object features comprises:
receiving a time-domain energy reflection signal from within the environment;
dividing the time-domain energy reflection signal into one or more windows comprising time-domain data; and
comparing the time-domain data in the one or more windows with known object responses from a database of object responses.

3. The method of claim 2, wherein receiving a time-domain energy reflection signal from within the environment comprises directing an energy source into the environment and receiving a reflection from the object within the environment with one or more receiving antennas.

4. The method of claim 2, wherein extracting the feature of the object response comprises modeling the object response with a piecewise parametric function of time and estimating parameters using a statistical signal processing estimation technique.

5. The method of claim 1, wherein classifying the object comprises estimating the physical location of the object in response to time-of-arrival information associated with the object response.

6. The method of claim 1, wherein classifying the object comprises comparing the time domain data with object responses recorded at one or more additional sensors to identify similar responses.

7. The method of claim 1, wherein classifying comprises:
comparing an object response received by one or more receivers with a reference response, the receivers defining an n×m array;
identifying an object response most similar to the reference response;
selecting a set of one or more initialization points associated with the object response that is most similar to the reference response;
estimating a location of a source of the object response;
predicting a time-of-arrival of the object response received by an unclassified receiver according to the location of the source of the object response;
comparing the predicted time-of-arrival of the object response with an actual time-of-arrival of the response acquired by the unclassified receiver; and
determining that the object response received by the unclassified receiver is associated with the source of the object response according to a determination that the time-of-arrival of the response received is substantially the same as the predicted time-of-arrival of the response, and the response received by the receiver is similar to a reference response.

8. The method of claim 1, comprising constructing a signal for generating a focused image in response to the estimate of the location of the object and one or more features of the object response.

9. The method of claim 8, wherein transforming the one or more feature vectors comprises substituting elements of the object response into a response model comprising a time-independent scaling factor, an object reference response, a time delay between an actual object response and a reference signal, and a damping factor.

10. The method of claim 1, further comprising:
identifying non-target signals corresponding to clutter; and
removing the non-target signals from the total signal.

11. The method of claim 10, wherein identifying non-target signals corresponding to clutter comprises:
transforming an object estimate and signal data into the frequency domain;
providing a parameter space from which to extract relevant features from the signals; and
removing a clutter estimate from the total signal.

12. The method of claim 11, wherein the transforming an object estimate and signal data into the frequency domain comprises identifying poles corresponding to clutter.

13. The method of claim 12, wherein the identifying poles corresponding to clutter comprises using the TLS-Prony method.

14. The method of claim 1, wherein the object is a tumor or diseased region of tissue, and the environment is tissue.

15. The method of claim 1, wherein the object is a tumor and the environment is breast tissue in proximity to the tumor.

16. A method for generating a three-dimensional image of a tumor, the method comprising:
irradiating body tissue with electromagnetic energy;
capturing reflections of the electromagnetic energy at a plurality of receivers;
generating a plurality of signals, each signal associated with the reflections captured by one of the plurality of receivers;
performing a tumor response estimation that extracts information related to a tumor response from the plurality of signals;
performing a tumor classification to identify and localize a source of a tumor response
and determine that the tumor response is associated with a tumor;
reconstructing the tumor response according to an object estimation reconstruction;
removing signals that do not correspond to reflections from the tumor; and
creating an image of the tumor, the image being substantially devoid of image artifacts.

17. The method of claim 16, wherein the energy is broad-band or ultra-wideband microwave energy.

18. The method of claim 16, wherein irradiating the body tissue with electromagnetic energy and the capturing reflections of the electromagnetic energy at a receiver is accomplished by an antenna that can both emit and receive microwave energy.

19. The method of claim 16, wherein imaging the object within the body tissue comprises processing signals from a tissue sensing adaptive radar apparatus.

20. A system comprising:
an energy source configured to irradiate an environment with electromagnetic energy;
a receiver configured to receive reflections of the electromagnetic energy from an object within the environment and generate a response signal associated with the received reflections;
a computing system coupled to the receiver, the computing system configured to execute predetermined instructions, the instructions comprising:
receiving the response signal corresponding to the reflections of the energy source;
extracting a feature of the object within the environment from the response signal reflected by the object;
estimating a location of the object within the environment from the object response;
comparing the feature of the object with a feature associated with an object of interest;
classifying the object in response to a physical location of the object and the comparison of the feature of the object with the feature of the object of interest;
reconstructing an object estimation in response to the classification; and
generating an image of the object in response to a determination that the object is classified as an object of interest.

21. A tangible computer program product comprising computer readable instructions that, when executed by a computer, cause the computer to perform operations comprising:
extracting a feature of an object response from a signal reflected by an object embedded within an environment; estimating a location of the object within the environment from the object response;
comparing the feature of the object response with a feature associated with an object response of interest;
classifying the object in response to a physical location of the object and the comparison of the feature of the object with the feature of the object of interest;
reconstructing an object estimation in response to the classification; and
generating an image of the object in response to a determination that the object is classified as an object of interest.
